(19) United States
(12) Patent Application Publication
(10) Pub. No.: US 2006/0123010 A1
(43) Pub. Date: Jun. 8, 2006

(54) System and method for managing data in a distributed computer system

(76) Inventors: John Landry, Wayland, MA (US); Phil Stanhope, Newbury, MA (US); Scott Durgin, North Andover, MA (US); Armando Neves, Boston, MA (US); Igor Kuklin, Acton, MA (US); Hossein Farkhondehpour, Waltham, MA (US); Mikhail Tchekmarev, Arlington, MA (US); Francis Tsai, Brookline, MA (US); Ying Su, Wayland, MA (US); Sabatino Gentile, Nashua, NH (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/229,311

(22) Filed: Sep. 15, 2005

Related U.S. Application Data
(60) Provisional application No. 60/707,837, filed on Aug. 12, 2005.
(60) Provisional application No. 60/609,990, filed on Sep. 15, 2004.
(60) Provisional application No. 60/610,016, filed on Sep. 15, 2004.
(60) Provisional application No. 60/609,948, filed on Sep. 15, 2004.
(60) Provisional application No. 60/609,989, filed on Sep. 15, 2004.
(60) Provisional application No. 60/610,079, filed on Sep. 15, 2004.

(51) Int. Cl. G06F 17/30

(52) U.S. Cl. 707/10

(57) ABSTRACT

Methods are provided for managing, sharing and providing access to data, especially among systems that are used to conduct a distributed application. Such methods may be beneficial, for example, in distributed networks having occasionally-connected devices. Methods are provided for linking and synchronizing data in a distributed network. In one example system, loosely-coupled systems may be used to implement such a network. Further, an abstraction layer may be used to abstract data elements (e.g., files, database elements) from those used by an application.

### RELATED APPLICATIONS

This application claims priority under 35 U.S.C. §119(e) to U.S. Provisional Application Ser. No. 60/609,990 entitled “SYSTEM AND METHOD FOR LINKING DATA,” filed on Sep. 15, 2004, U.S. Provisional Application Ser. No. 60/610,016 entitled “SYSTEM AND METHOD FOR SHARING CONTENT,” filed on Sep. 15, 2004, U.S. Provisional Application Ser. No. 60/609,948 entitled “SYSTEM AND METHOD FOR SYNCHRONIZING DATA,” filed on Sep. 15, 2004, U.S. Provisional Application Ser. No. 60/609,989 entitled “SYSTEM AND METHOD FOR SHARING CONTENT,” filed on Sep. 15, 2004, U.S. Provisional Application Ser. No. 60/610,079 entitled “SYSTEM AND METHOD FOR AUDITING DATA,” filed on Sep. 15, 2004, and U.S. Provisional Application Ser. No. 60/707,837 entitled “METHOD AND APPARATUS FOR MANAGING DATA IN A DISTRIBUTED NETWORK,” filed on Aug. 12, 2005, each of which applications are herein incorporated by reference in their entirety.

### FIELD OF THE INVENTION

The application relates generally to information sharing, and more specifically, to the management, synchronization and sharing of data among multiple computer systems.

### BACKGROUND

There are many methods for sharing data among computer systems. Such methods include, for example, the traditional client-server model used for sharing information among users in an enterprise computing system. This model generally includes one or more server-based software systems that store data centrally, and provide this data to users as necessary. Users generally operate static computer systems (e.g., a PC) that are coupled to the server-based systems by dedicated network connections. Such systems usually have one or more static software applications that communicate with other computer systems using different types of programming interfaces and protocols.

Business today requires technology that is readily adaptable to customer's changing needs—all at a cost that the customer is willing to pay. Historically, the availability (or lack thereof) of technology directed the business practices of companies are limited by the computing systems. Their limitations translate into limits to the business offerings of a company. Such computing systems are generally fixed and have a high dependency on associated systems. For these reasons, conventional systems are not conducive to change, and thus, business offerings and growth thereof are limited.

### SUMMARY

An improved method is needed for sharing and providing access to data, especially among occasionally-connected systems that are used to conduct a distributed application. Such occasionally-connected systems may include, for example, PDAs, cell-phones, laptops and other systems that do not have a persistent data connection. According to one aspect of the present invention, it is realized that the conventional server-centric model does not work well for occasionally-connected systems, as these applications generally require network connections to be present. Applications developed in the server-centric model generally do not work optimally for occasionally-connected systems, and generally do not provide the functionality or performance of “typical” enterprise clients. What is needed is a solution that permits occasionally-connected systems to execute applications more efficiently, and with more features that may be performed while the system is in a disconnected mode. Such a solution would be beneficial to organizations having mobile personnel that use occasionally-connected systems, such as field service organizations, field sales, or other organizations having personnel dispersed outside of the traditional enterprise network. However, it is realized that such a solution may also be beneficial in the enterprise as well.

In one aspect of the present invention, there is a need to provide real-time access to database tables through an occasionally-connected system, and to perform operations on such tables while in a disconnected state. In one example, such databases are SQL databases commonly accessed through an enterprise network, usually by hosts having persistent links to a server hosting the SQL database.

In another aspect of the present invention, existing database tables are linked without the need for generating new programs to interface with the SQL database. Traditionally, access to such data necessitates the development of one or more custom programs that communicate with the SQL database. Such programs are static, requiring modification if there is a change in the schema of the SQL database. Rather, according to one embodiment of the present invention, an SQL table is linked with a table existing on an occasionally-connected device, and the tables are linked. Thus, the occasionally-connected system may perform updates to the local table, which are then synchronized with the SQL database when convenient.

According to another aspect of the present invention, a capability is provided for allowing occasionally-connected or permanently-connected systems to share content with an application server system. One example of such an application server system is a collaboration management system such as the well-known SharePoint™ collaboration system provided by the Microsoft Corporation. The SharePoint system provides the ability to share files and other content among Microsoft Windows clients (e.g., PCs). However, such systems do not typically work with occasionally-connected systems, as such collaboration management systems generally require that each component system be connected to update a common data file or other content which is centrally-located. Rather, according to one embodiment of the invention, an occasionally-connected system is permitted to perform an action local to the occasionally-connected system while the system is in a disconnected state. For example, a user on an occasionally-connected system can update a local copy of a database table, and these updates can be synchronized at a later point when the occasionally-connected system is in a connected state. An advantage of this capability is that it provides the user with the ability to update content supported by the collaboration management system while in a disconnected state.

Further, such application servers have different interfaces, data, and protocols, and client systems that communicate with such systems generally need to be customized to facilitate a distributed application. According to one embodiment, data provided through a standard interface of an application server (e.g., a SharePoint server) is analyzed to determine application metadata. The metadata is used to determine application data and functionality, and such metadata is stored in a database and made available to clients to perform application functions. In this way, functionality of the application server may be extended easily to clients.

According to another aspect of the present invention, a capability is provided to allow an occasionally-connected device to perform local database transactions (e.g., on an SQL database) while in a disconnected state. To provide this capability, a trigger is defined on one or more elements of the SQL table or the table stored on the occasionally-connected system. Such a trigger defines operations that may be performed (e.g., insert, update, delete) on each element of the SQL database.

According to another aspect of the present invention, a capability is provided for allowing end-users to publish and/or subscribe to content using occasionally-connected systems. According to one embodiment, a user is permitted to subscribe to and/or share content with other occasionally-connected devices in a peer-to-peer manner. According to one example system, a database-driven application is provided that facilitates sharing of files. In one specific example, files are uniquely identified and abstracted to an occasionally-connected system. A user of the occasionally-connected system may select one or more files or group of files to subscribe, and the underlying system may be capable of downloading the one or more files as necessary through the data-driven application. A synchronization engine may be capable of synchronizing content referenced by a unique identifier to the occasionally-connected system.

According to yet another aspect of the present invention, a capability is provided for auditing changes made to data in an occasionally-connected computing model. Such changes may be determined and signed at the occasionally-connected system, allowing an audit trail to be created. Because, according to one embodiment, changes in data are determined and signed at the occasionally-connected system, centralized changes in data (e.g., by an administrator in a central database) cannot occur without detection.

According to one aspect of the present invention, it is appreciated that loosely-coupled technologies—where the components of the distributed applications have minimal or no dependence on each other—may be used to allow businesses more flexibility to augment, change or replace functionality in their computing system(s). Such loosely coupled technology in turn may allow businesses to effect changes to meet the developing needs of their customers and be responsive to market trends, in a timely manner to distinguish themselves from their competitors.

Businesses and consumers need flexibility in their computing systems to modify their solutions to adapt and optimize for each problem or opportunity they encounter. Persistent changes in computing needs require business and/or personal applications to be constantly modified. Older, distributed object systems—with no particular object-oriented standard or language generally do not create business value or improved efficiency for users. These tightly coupled systems require that all activities be defined with zealous precision and then hard-wired (i.e., coded) into a particular object. Although there have been some advances in today's application architectures, the requisite exhaustive requirements gathering process and lengthy development schedules still present real challenges in adopting the iterative development model needed by business.

According to one aspect of the present invention, it is appreciated that newer technologies and architectures must provide the flexibility to easily change with a user's needs. Such systems may be, for example, in the form of loosely-coupled systems. In traditional loosely-coupled systems, the modules or components of the distributed application minimize or eliminate dependencies on each other. According to one aspect of the present invention, it is appreciated that distributed applications are an ideal format for newer loosely-coupled technologies because each application can be accessed across multiple computing devices (laptop, PPC, tablet PC, standard PC, etc.) that can communicate with each other, and that appear to users as parts of a single, larger, warehouse of shared hardware, software and data. This structure provides users with the ability to continually re-examine and change their activities in response to customer or internal needs. Loosely-coupled architectures also allow individuals and/or organizations to take a very integrated approach to computing solutions by allowing multiple programs and systems not possible before.

To continue to provide a flexible approach to computing solutions, the next generation of distributed solutions may have the capability to adapt to, and integrate with, programs and applications that come in the future. The ability to make changes to the business process without changing the code base and facilitating integration with current and future technology is an ultimate goal of developing technology. Distributed software systems, according to one embodiment of the present invention, enable the end-to-end integration of people, business processes, and information systems within and beyond the commercial enterprise.

According to one aspect of the present invention, a platform is provided to permit additional functionality to be easily modified, integrated, managed and distributed across a distributed computing system. One example of a distributed computing system in which such a platform may be provided includes an enterprise computing system having one or more mobile systems. One such distributed system in which various aspects of the present invention may be implemented includes the Adesso system which is an end-to-end software solution for developing, deploying and managing mobile applications. Further, various aspects of the invention relate to improving the Adesso system to support various aspects of the present invention. Although the Adesso platform may be used, it should be appreciated that other platforms may be used to implement various aspects of the present invention.

The Adesso system provides a platform on which users with permanent access to the Internet (i.e., the office environment) or occasional access (i.e., mobile technology) can read, explore, analyze, act and collaborate on the data stored within the system. In addition, the Adesso system provides equivalent capabilities with externally stored data and programs by easily integrating them with the platform. At its core, the Adesso platform is designed as a distributed solution with self-describing applications, support for a rich store complete with multimedia support, and a driving assumption that dynamic modification of applications should be possible without having to code. According to one embodiment, the Adesso system provides a general-purpose computing platform that is malleable enough to be able to function with whatever application platforms that may be needed.

The Adesso platform, according to one embodiment of the present invention, is a loosely-coupled, services-oriented, distributed data architecture that is able to integrate with “smart applications.” According to one embodiment of the present invention, a distributed data architecture is provided wherein elements defined in the platform (both traditional data and also the metadata defining a schema) is stored as data within a relational or other type of database. Database entities such as tables, fields, views, forms, filters, user permission information, etc. are stored within the platform as data—allowing for dynamic alteration of either the schema information or data populating these tables without having to change any code. In the platform, data may be stored in a relational or other type of database, and abstracted to applications running on a particular device. Further, aspects of the application may be stored as database elements and instantiated as needed from the database.

According to one embodiment of the present invention, smart applications built on the Adesso platform have local intelligence that allows a user to take advantage of the system being used—e.g. the system's processors, storage, peripheral devices, etc. For any particular instantiation of an intelligent Adesso application, a configuration is adopted that contains only the components necessary for the individual device, time, user, location, etc. In addition, a smart application can execute whenever the application needs to regardless of the device, or the state of Internet connectivity. The power of Adesso's distributed data architecture comes from the combination of the core architecture described above in combination with a powerfull synchronization engine (that syncs both data (e.g., database elements, metadata, files, etc.), and a dynamic application creation tool. Generally, the Adesso architecture includes an Adesso server and an Adesso client. However, the Adesso system may be coupled to any conventional system (e.g., a legacy enterprise database, application, file system, etc.) to permit mobile applications to access and use data provided by such systems.

According to one embodiment of the present invention, the Adesso platform provides container-based (i.e., files and file-folders) business process automation for computing devices. Such devices may have permanent network connectivity (e.g., Internet and/or enterprise network access in an office environment) and/or occasional connectivity (e.g., mobile devices).

Conventionally, file systems and their organizational structures are used to organize and locate file data. For instance, in a file system of a personal computer(PC), files may be located in one or more folders created by a user. However, the data associated with such files is local to the PC, and serves as a resource only to the particular system. Likewise, shared storage provides limited organizational functions, with some ability to share files among users.

However, according to one embodiment of the present invention, actions performed on representations of files, folders and other organizational structures are used to effect business processes. For example, a user, by placing a file in a particular folder, may cause that file or elements of that file to be synchronized with other data, distributed to one or more users, or any other action.

In one specific example, consider an expense report application involving personal expense reports prepared by individuals of a company. Such expense reports may need to be reviewed by a manager prior to submittal for reimbursement. One such individual may operate an Adesso application that operates on at least one portion of the expense report. The expense report may be, for example, a spreadsheet file. The user may be presented an interface that permits him/her to open and edit the spreadsheet file, and to organize spreadsheet and other types of files into organizational units (e.g., folders). When the expense report has been completed, for example, the user may select the file and place the file in a “Submitted” or other type of folder. Rules may be created that cause the file (or a portion thereof) to be transferred to one or more recipients (e.g., a manager). Such rules may be, for example, rules using data values of the database to trigger appropriate actions.

Further, rules may be defined to allow a person (such as a manager) to be alerted to the presence of the report, or otherwise prompted to review and approve the report. In another application, figures from the report may be extracted to produce other reports (upon one or more actions with the file), to be accessed by other users, for example. In this way, folders and other organizational units may be used to enforce business processes.

In another example, an ecommerce application may be developed using container-based business process management. In one specific example, users (purchasers) may purchase items by placing them into folders or other container type (e.g., a cart). The items may be, for example, categorized and presented as items in a folder, which may be dragged and dropped into a cart for purchase. The items may have, for example, associated database entries that provide data related to the item such as, for example, price, size, weight, a picture of the item, among other information. An action on the client (e.g., dropping an item into a cart) may cause an action (e.g., a purchase operation, credit card charge, update of a website database) to be performed on the server (e.g., an Adesso server).

In addition to automating business processes, according to one embodiment of the present invention, technology can also be used for private consumers to automate any required processes as needed. In another example, such a system may be used to distribute content such as media files. In one specific example, a content manager that permits a user to download and view particular media (e.g., pictures, music, video, etc.) on a mobile system (e.g., a device such as a laptop, PDA, cell phone, etc.) may be provided that implements various aspects of the present invention. For instance, a mobile user may be permitted to “subscribe” to a particular folder containing content (e.g., in the form of media files). As a result of the act of subscribing, the user may be presented an indication of the files listed in the particular folder, and may be permitted to select one or more of the files for playing on the mobile device. When changes are made to the folder, the user may be presented an indication of any updates.

Moreover, the application program that views such a file may be dynamically synchronized and transferred to the mobile device. The application may be in the form of a “plug-in” program that is associated with the mobile device. The association may be made, for example, when a user selects a particular subscription, opens a particular file type, etc. Any associated files to support the plug-in program may be transferred (e.g., during a synchronization action performed with the mobile device) and used to access the particular file. Particular plug-in versions, files, etc. may be loaded depending on the device capability, user, permissions, or any other parameter. In one example, metadata related to a particular file is used to trigger one or more rules. For instance, a .JPG extension and/or metadata in the file may be used to trigger an association and synchronization of a viewer program with the mobile device. Thereafter, the mobile device may be permitted to access the file. Metadata may be extracted an stored for each file in the system. Metedata “crackers” may be provided as programs that may inspect and determine metadata associated with particular file types.

Another example of a business process using files includes a file explorer user interface. As conventionally used, “conventional” file folders and views of files as provided by operating systems (e.g., Microsoft Windows NT, Microsoft Windows Visa, etc.) provide limited information about files on the system. Such information usually includes, for example, the file name, file size, and type of file. However, according to one embodiment of the present invention, additional file data may be used to create an improved file viewing interface. In one specific example, files may be accessed and arranged through an Adesso application, where files are managed and organized using a database structure that describes the files and includes metadata information. Such metadata may be, for example, extracted from the file, created by the user, or relate to the file itself. In one example,

Because operations relating to the file (e.g., view, sort, navigate, etc.) can be performed using a database structure, the operations are more robust. The application of a structured data system (e.g., a relational database) to unstructured data (e.g., files) allows a user to more effectively organize the unstructured data. Because, according to one embodiment, unstructured data is accessed using a relational data model, the unstructured data may be queries, and operations may be performed using the relational data model. Such an file explorer application may be provided transparently to the user, as files may be sorted, dragged, and dropped using a similar interface as conventional file management tools.

The platform may be capable of providing profile-based synchronization of data. A person (a user) has many “personas” for accessing data—a single person may use multiple devices for accessing data (laptop, PDA, cell phone, Internet kiosk, friend's computer, etc.) and therefore, a system that provides such access may be beneficial. According to one embodiment, access to information is provided to a user from any of a number of personas. In one specific example, a user may be permitted to access file information from a PDA and a laptop. In particular, the PDA may not have the processing capability of viewing the file in its native form (e.g., a Microsoft Excel spreadsheet), but may be permitted to view the information contained in the file, depending on the capabilities of the PDA. This may be accomplished, for example, by uniquely identifying elements of the file and extracting the information contained therein to other systems, and by permitting those elements to be synchronized and updated, among systems (e.g., using synchronization functions). In this way, a common view of data may be provided to a user from multiple personas. Further, the user's access to data may be made consistent across personas, and the most appropriate data may be provided depending on the persona used and operations performed using that persona.

The platform provides the ability to selectively determine business processes or other type of automation based on the presence, absence, and/or given-state of one or more files, folders, and/or containers, and data stored therein. At a high level of abstraction, this unique capability is accomplished, for example, by programmatically synchronizing data and/or metadata content with a relational database and further employing a sophisticated synchronization engine that allows this and other content (related and/or unrelated) to be shared with one or more users, systems, devices and/or programs.

According to one embodiment of the present invention, a system is provided for data consumption, storage, routing, and/or discretionary sharing that is designed to reflect the business processes or other consumer needs of a client system (e.g., an Adesso client system). Additionally, the Adesso platform facilitates the dynamic alteration of those processes as required by the client. A product instantiation can be, depending on permissions, a super-, same- or sub-set of the content relative to other users. For instance, depending on the role of the user, that user may be able to access one or more portions of an application and its associated data (e.g., as defined in the database). There may be many factors that may be used to drive which application components and data get instantiated for a particular user: the type of device used by the user and the device's capacities (memory, storage, processing power, network availability, bandwidth, etc.), the user's job responsibilities, role, office location, etc. According to one embodiment, a synchronization process can be controlled to incorporate any factor into the synchronization engine logic to control content (e.g., data files and portions thereof) and application distribution upon synchronization.

According to one aspect of the present invention, a method is provided for transferring file data. In one example, the method provides the ability to perform on-demand file downloads (e.g., to mobile devices). In the case of transferring file data to mobile devices, there may be system limitations (e.g., memory, storage, bandwidth, display capabilities, etc.) for accessing large amounts of data. According to one embodiment, synchronization settings may be set based on a device's resources to limit the amount and/or size of files transferred to a mobile device. Such downloads may be adjusted based on actions performed by a user (e.g., subscribing to one or more media files). Further, the type and format of files sent to the device may be adjusted based on the device's capabilities. For instance, a synchronization program may transfer a particular file version to a mobile device based on its capabilities. In one particular instance, a video file having a particular resolution that matches the mobile device may be sent to the mobile device instead of a higher-resolution file which may be sent to a personal computer (PC). These separate versions of the files may be abstracted to the application on the mobile device and PC, and the user of either system may not need to determine which file should be loaded. Rather, the file loaded is determined by one or more rules based on the capability of the device accessing the file. In this way, the most appropriate method (e.g., application, file type, portion of the data, etc.) may be presented to the user without their knowledge of the proper access method.

Further, a robust transmission method is provided for transferring information in casually-connected systems. More particularly, if a synchronization is interrupted due to connection failure, a method is provided for resuming download of the information. Further, a method is provided to address the downloading of large files, which, according to conventional synchronization methods, would normally not be synchronized due to their size. Such methods may be useful in transferring binary data which may be relatively large, such as media files.

According to one aspect of the present invention, a method is provided for sharing data between an occasionally-connected system and a database, the database being located on at least one database server coupled to a network is provided. The method comprises acts of linking, to the database, one or more remote database elements stored in the occasionally-connected system, performing a transaction involving the one or more remote database elements, and synchronizing, by the occasionally-connected system, the one or more remote database elements upon which the transaction was performed. According to one embodiment of the invention, the transaction includes at least one of an insert, an update and a deletion.

According to another embodiment of the invention, the act of linking further comprises an act of relating, through an abstraction layer, at least one of the one or more remote database elements to a data entity stored in the database. According to another embodiment of the invention, the data entity includes a file. According to another embodiment of the invention, the data entity includes a database entry stored by a database program. According to another embodiment of the invention, a distributed computing system comprises the occasionally-connected system and the database server, and wherein the method further comprises an act of identifying, by an identification layer, a database element within the distributed computing system. According to another embodiment of the invention, the act of identifying further comprises an act of uniquely identifying the database element within the distributed computing system.

According to one aspect of the invention, the method further comprises an act of relating a database element of the database server to a remote database element of the occasionally connected system. According to another embodiment of the invention, the method further comprises linking the database element of the database server to the remote database element of the occasionally connected system through the unique identification. According to another embodiment of the invention, the occasionally-connected system includes a mobile computing system. According to another embodiment of the invention, the method further comprises an act of downloading, to the mobile computing system, at least one database element of the database server, and wherein the act of downloading is performed in response to an occurrence of a contextual event. According to another embodiment of the invention, the contextual event is responsive to an action performed by a user operating the mobile computing system. According to another embodiment of the invention, the act of downloading includes an act of downloading a file to the mobile computing system. According to another embodiment of the invention, the file is associated with a remote database element of the mobile computing system.

According to another embodiment of the invention, the contextual event is responsive to an action performed by a user operating the mobile computing system. According to another embodiment of the invention, the method further comprises an act of relating, through the abstraction layer, a plurality of data entities, at least two of which being associated with respective data sources, to a single application executing on the occasionally-connected system. According to another embodiment of the invention, the act of synchronizing includes an act of synchronizing data associated with the plurality of data entities with the single application. According to another embodiment of the invention, the method further comprises an act of presenting, to a user of the occasionally-connected system, an interface including the data associated with the plurality of data entities. According to another embodiment of the invention, the single application is a database-driven application. According to another embodiment of the invention, the single application is a late-bound application.

According to one aspect of the invention, a method for sharing content among an application server system and an occasionally-connected client is provided. The method comprises acts of storing, at the occasionally connected client, a reference to a remote resource managed by the application server system, and while the occasionally-connected client is in a disconnected state, permitting the occasionally-connected client to perform a transaction on the referenced resource. According to another embodiment of the invention, the application server system includes a collaboration management system. According to another embodiment of the invention, the method further comprises an act of determining metadata associated with data of the application server. According to another embodiment of the invention, the act of determining metadata includes an act of determining the metadata through an interface of the application server. According to another embodiment of the invention, the interface provides access to the associated data, the data describing functionality of a distributed application. According to another embodiment of the invention, the application server includes a SharePoint application server. According to another embodiment of the invention, the referenced resource includes application data. According to another embodiment of the invention, the referenced resource includes a data entity. According to another embodiment of the invention, the data entity is at least one of a file and a database entry.

According to another embodiment of the invention, the method further comprises an act of uniquely referencing the referenced resource. According to another embodiment of the invention, the method further comprises assigning a unique identifier to the referenced resource. According to another embodiment of the invention, the reference resource is isolated from the occasionally connected client by an abstraction layer. According to another embodiment of the invention, the abstraction layer performs the act of assigning the unique identifier to the referenced resource. According to another embodiment of the invention, the occasionally connected client is capable of accessing data not associated with the referenced resource. According to another embodiment of the invention, the method further comprises performing a function that involves data associated with the referenced resource and the data not associated with the referenced resource. According to another embodiment of the invention, the function includes at least one of a superset of functions not performed by the application server system.

According to one aspect of the invention, a method for sharing data among a plurality of occasionally-connected systems is provided. The method comprises acts of storing, at a first occasionally-connected system, a reference to a resource, and presenting the reference, in a file system of the first occasionally-connected system, as a local resource in the file system. According to another embodiment of the invention, the resource is stored at a remote location from the first occasionally-connected system. According to another embodiment of the invention, the resource is stored locally in a file system of the first occasionally-connected system. According to another embodiment of the invention, the method further comprises an act of determining metadata associated with the resource, and storing the metadata in a database. According to another embodiment of the invention, the method further comprises an act of locating the resource using the database. According to another embodiment of the invention, the act of determining metadata includes an act of analyzing data within a file associated with the resource. According to another embodiment of the invention, the method further comprises an act of determining a file format associated with the file, and determining metadata based on the determined file format.

According to another embodiment of the invention, the file system is presented to a user by a user interface, the user interface including a representation of the reference to the resource. According to another embodiment of the invention, the representation is selectable by the user, and when selected, causes the resource to be downloaded to the first occasionally-connected system. According to another embodiment of the invention, the representation includes a representation of a folder, and wherein the method further comprises presenting, through the user interface to the user, a representation of the folder. According to another embodiment of the invention, the method further comprises an act of downloading, in response to a selection of the folder representation, a list of one or more items contained by the folder. According to another embodiment of the invention, the method further comprises an act of downloading representations of the one or more items contained by the folder. According to another embodiment of the invention, the method further comprises an act of triggering a downloading of at least one of the one or more items in response to a selection of the at least one item by the user. According to another embodiment of the invention, the user interface is presented through an extension of an operating system of the first occasionally-connected system. According to another embodiment of the invention, the operating system is a WINDOWS-type operating system, and wherein the extension is performed using shell extension.

According to one aspect of the invention, the method further comprises an act of presenting a view of the file system using information derived from the file system. According to another embodiment of the invention, the information includes metadata derived from a portion of at least one file, and wherein the method further comprises an act of determining the view of the file system based on the derived metadata. According to another embodiment of the invention, the method further comprises an act of permitting the user to perform at least one operation using the interface, the at least one operation comprising at least one of sorting files, filtering a listing of files, and presenting a view of files. According to another embodiment of the invention, the method further comprises an act of storing the derived metadata in a relational database. According to another embodiment of the invention, the first occasionally-connected system includes a mobile computing system.

According to one aspect of the invention, in a distributed computing system, a computer-implemented method for managing data is provided. The method comprises acts of presenting, to a user, a representation of container, accepting, from the user, an action relating to the container, and executing a business process in response to the act of accepting. According to one embodiment of the invention, the action includes the user selecting the container. According to another embodiment of the invention, the action includes the user selecting one or more files in the container. According to another embodiment of the invention, the action includes the user placing a file in the container. According to another embodiment of the invention, the container includes at least one associated file, and wherein the method further comprises an act of associating the at least one associated file with a database entry of the distributed computing system.

According to another embodiment of the invention, the method further comprises an act of identifying the at least one associated file within the distributed computing system. According to another embodiment of the invention, the act of identifying further comprises an act of uniquely identifying the at least one associated file within the distributed computing system. According to another embodiment of the invention, the file is a media file comprising at least one of audio data and video data. According to another embodiment of the invention, the method further comprises an act of accessing the file using the database entry. According to another embodiment of the invention, the method further comprises an act of performing a database search, a result of the database search providing the database entry. According to another embodiment of the invention, the acts of presenting and accepting are performed by a mobile computing system operated by the user. According to another embodiment of the invention, the method further comprises an act of downloading, to the mobile computing system, information relating to the container. According to another embodiment of the invention, the act of downloading is performed in response to an occurrence of a contextual event. According to another embodiment of the invention, the information relating to the container includes a listing of one or more files associated with the container.

According to one aspect of the invention, a method for providing content among a plurality of occasionally-connected systems over a communication network is provided. The method comprises acts of providing for, at least one of the plurality of occasionally-connected systems, an indication by a user of the occasionally-connected system, a resource to be retrieved, and retrieving, during a period of a connection of the at least one of the plurality of occasionally-connected systems to the communication network, the resource in response to the indication.

According to one aspect of the invention, a method for auditing data in a network including a plurality of occasionally-connected systems is provided. The method comprises acts of storing, at an occasionally-connected system, a portion of data, determining, at the occasionally-connected system, a change of the portion of data, and determining, at the occasionally-connected system, a signature of the change, and associating the signature with the portion of data. According to one embodiment of the invention, the method further comprises an act of transferring an indication of the change to at least one other system. According to another embodiment of the invention, the at least one other system includes a server coupled to the occasionally-connected system. According to another embodiment of the invention, the at least one other system includes another occasionally-connected system coupled to the occasionally-connected system. According to another embodiment of the invention, the method further comprises an act of determining if the portion of data has been changed on at least one other system. According to another embodiment of the invention, the change includes at least one of adding a record, deleting a record, and modifying a record. According to another embodiment of the invention, the change includes at least one of modifying a database schema associated with the portion of data, and modifying an application design associated that processes the portion of data. According to another embodiment of the invention, the change includes a change in an entry of a database table.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a general purpose computer system upon which various aspects of the present invention may be practiced;

FIG. 2 shows a system architecture suitable for implementing various aspects of the present invention;

FIG. 3 shows an example data flow in a system according to one embodiment of the present invention;

FIG. 4 shows an example client architecture suitable for implementing various aspects of the present invention;

FIG. 5 shows an example server architecture suitable for implementing various aspects of the present invention;

FIG. 6 shows an example synchronization process according to one embodiment of the present invention;

FIG. 7 shows an example server synchronization system according to one embodiment of the present invention;

FIG. 8 shows an example relation through an abstraction layer according to one embodiment of the present invention;

FIG. 9 shows an example data flow in a system according to one embodiment of the present invention; and

FIGS. 10A-10B show an example file synchronization process according to one embodiment of the present invention.

### DETAILED DESCRIPTION

The following examples illustrate certain aspects of the present invention. It should be appreciated that although these examples are provided to illustrate certain aspects of the present invention, the invention is not limited to the examples shown. Further, it should be appreciated that one or more aspects may be implemented independent from any other aspect. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

As discussed above, one aspect of the present invention relates to conducting a distributed application. Such an application may be conducted using various computer systems, some of which may be occasionally-connected to a communication network. Various aspects of the present invention relate to methods for managing data between systems, and aspects relating to using such methods to achieve higher-level functions. It should be appreciated that these aspects may be practiced alone or in combination with other aspects, and that the invention is not limited to the examples provided herein. According to one embodiment, various aspects of the present invention may be implemented on one or more general purpose computer systems, examples of which are described below.

General Purpose Computer System

Various embodiments according to the present invention may be implemented on one or more computer systems. These computer systems may be, for example, general-purpose computer systems such as those based on Intel PENTIUM-type processor, Motorola PowerPC, AMD Athlon or Turion, Sun UltraSPARC, Hewlett-Packard PA-RISC processors, ARM processors, or any other type of processor. For instance, computer systems such as personal computers (PCs), laptops, cell phones, personal digital assistants (PDAs), or other types of computer systems may be used. It should be appreciated that one or more of any type computer system may be used to manage data in a distributed system according to various embodiments of the invention. Further, it should be appreciated that various aspects of the present invention may be practiced on a single computer or may be distributed among a plurality of computers attached by a communications network.

A general-purpose computer system according to one embodiment of the invention is configured to perform any of the described data management functions, including but not limited to, storing, synchronizing, sharing, and retrieving data as part of a distributed application. It should be appreciated that the system may perform other functions, including creating distributed applications, linking data entities, etc., and the invention is not limited to having any particular function or set of functions.

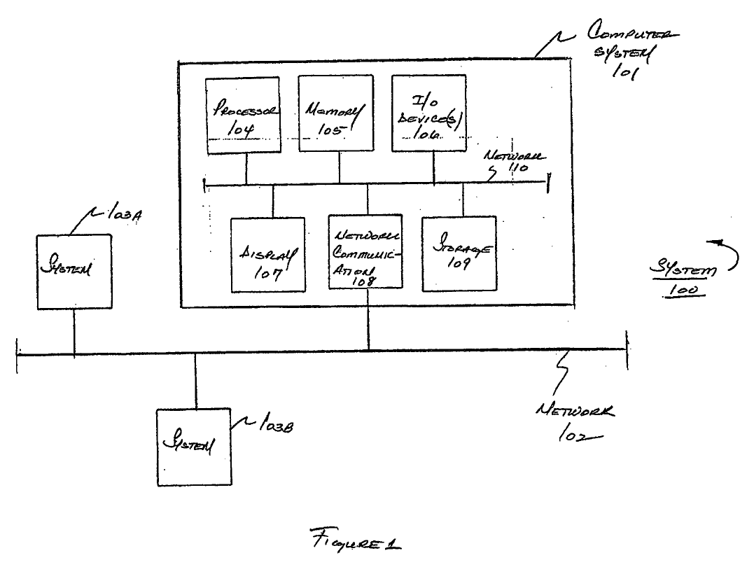

FIG. 1 shows a block diagram of a general purpose computer and network system in which various aspects of the present invention may be practiced. For example, various aspects of the invention may be implemented as specialized software executing in one or more computer systems including general-purpose computer system 101 shown in FIG. 1. Computer system 101 may include a processor 104 connected to one or more memory devices 105, such as a disk drive, memory, or other device for storing data. Memory 105 is typically used for storing programs and data during operation of the computer system 101. Components of computer system 101 may be coupled by an interconnection mechanism such as network 110, which may include one or more busses (e.g., between components that are integrated within a same machine) and/or a network (e.g., between components that reside on separate discrete machines). The interconnection mechanism enables communications (e.g., data, instructions) to be exchanged between system components of system 101.

Computer system 101 also includes one or more input/output (I/O) devices 106, for example, a keyboard, mouse, trackball, microphone, touch screen, a printing device, display screen, speaker, etc. In addition, computer system 101 may contain one or more interfaces (e.g., network communication device 108) that connect computer system 101 to a communication network (in addition or as an alternative to the network 110.

The storage system 109, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 109, as shown, or in memory system 105. The processor 104 generally manipulates the data within the integrated circuit memory 104, and then copies the data to the medium associated with storage 109 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 101 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architectures or components that that shown in FIG. 1.

Computer system 101 may be a general-purpose computer system that is programmable using a high-level computer programming language. Computer system 101 may be also implemented using specially programmed, special purpose hardware. In computer system 101, processor 104 is typically a commercially available processor such as the well-known Pentium class processor available from the Intel Corporation. Many other processors are available. Such a processor usually executes an operating system which maybe, for example, the Windows-based operating systems (e.g., Windows NT, Windows 2000 (Windows ME), Windows XP, Windows Vista operating systems) available from the Microsoft Corporation, MAC OS System X operating system available from Apple Computer, the Solaris-type operating systems (e.g., Solaris 10) available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within system 100. For instance, the system may be a distributed system (e.g., client server, multi-tier system). In one example, the system includes software processes executing on a system associated with a user (e.g., a client system). These systems may permit the user to execute a distributed application.

Example System Architecture

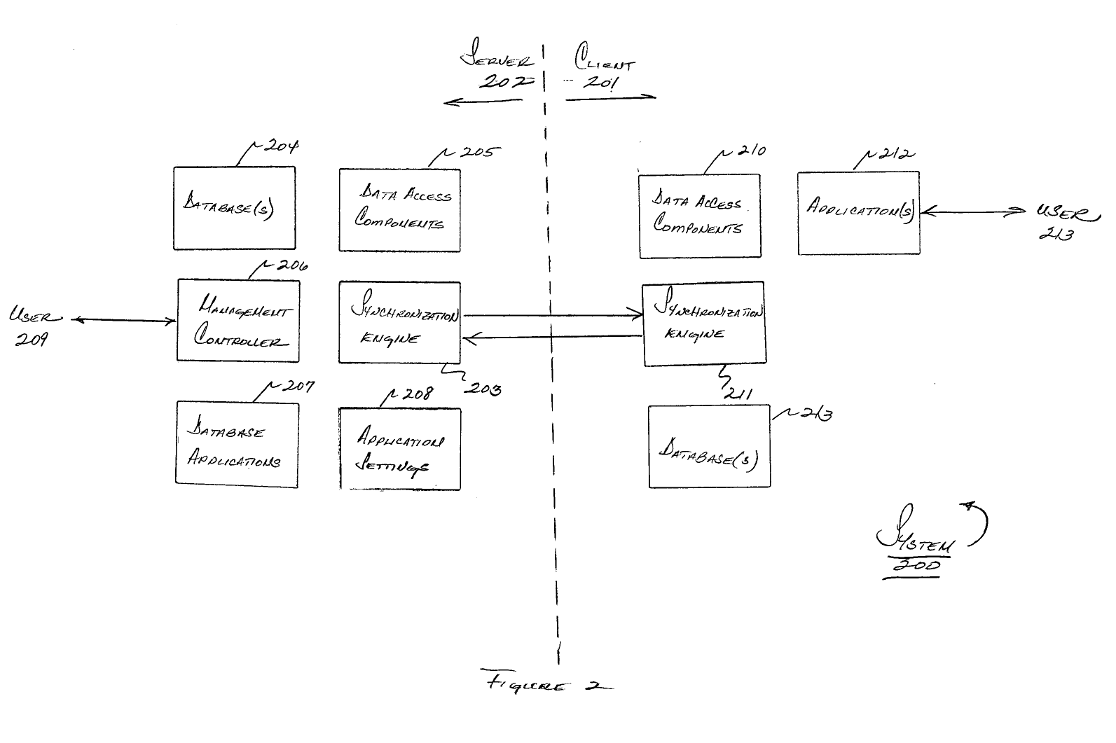

FIG. 2 shows an architecture diagram of an example system according to one embodiment of the invention. It should appreciated that FIG. 2 is used for illustration purposes only, and that other architectures may be used to facilitate one or more aspects of the present invention. As shown in FIG. 2, a distributed system 200 may be used to conduct a distributed application. System 200 may include one or more computer systems (e.g., client system 201, server system 202) coupled by a communication network. Such computer systems may be, for example, general-purpose computer systems as discussed above with reference to FIG. 1. Although there are references herein to entities referred to as “servers” and “clients,” it should be appreciated that various aspects of the present invention may be used with any type of system. For instance, client 201 and server 202 may be peer computer systems on a computer network.

In one embodiment of the present invention, system 201 includes one or more applications 212 though which one or more users 213 interact. Applications 212 may be any type of application, for example, business applications such as a shipping software for managing shipping and delivery functions, sales force automation tools, or any other application type. Also, applications 212 may include non-business applications such as media sharing applications, file sharing applications, etc. According to one aspect of the present invention, such applications are data-driven applications that depend on one or more databases.

According to one embodiment, client 201 includes one or more database tables that define the applications and the data that they use and manage. These tables are local database tables stored in a memory of client 201, and applications are capable of performing transactions (e.g., insert, update, deletion) actions on these tables. According to one specific embodiment, the application features, functions, and behaviors are defined by a portion of the database, and are defined at runtime. Because of this, the application and its data may be updated using database operations.

To this end, a synchronization engine 211 is provided that synchronizes data between the client 201 and server 202. Synchronization engine 211 may, for instance, use one or more protocols or combinations thereof to transfer database and file data. In one example, engine 211 may use Direct Internet Message Encapsulation (DIME) over transport protocols such as HTTP and TCP. Other protocols may be used to transfer such data (e.g., FTP, BITS, etc.), and it should be appreciated that the invention is not limited to any particular protocol.

Synchronization engine 211 may be capable of initiating synchronization and/or capable of accepting data initiated from other systems. As discussed further below, data (e.g., files, database entries, etc.) may be shared and updated in a distributed network among clients, servers, and other systems. It follows that synchronization engine 211 may be capable of synchronizing database entries, binary data (e.g., applications, files, etc.) among other data formats. In one example, database records are exchanged using XML format, but other formats (e.g., binary) may be used. Because data may be shared and acted on by multiple entities, conflicts may exist. There may be one or more rules defined at the server and/or client to handle such conflicts. Also, according to one embodiment of the present invention, synchronization engine 211 may be capable of transferring file data efficiently, and in an on demand manner depending on a user action (e.g., a file selection).

Client 210 may include one or more data access components 210 that permit applications (e.g., application(s) 212) to access one or more databases (e.g., database(s) 213). Such components may include one or more programs or drivers that facilitate an interface to a database system.

Synchronization engine 211 may communicate data to another synchronization engine 203 associated with server 202, engine 203 having similar capabilities and functions as engine 211. Server 202 may also include one or more databases 204 (e.g., a relational or other type of database) having data that is accessed by client 201. According to one embodiment, the application executed by the client is a data-driven application defined by a database schema stored in server 202. Such databases may be located on server 202, or server 202 may serve as a conduit to other systems having one or more databases. To this end, server 202 may also include data access components 205 to access such databases.

Server 202 may also include one or more applications (e.g., database application 207) with which data is synchronized. The applications may include one or more application settings 208 (e.g., synchronization rules, access rules, etc.) that define how the application is conducted and how data is managed between the client and the server. Settings 208 may also be stored in a database.

Server 202 may also include a management component 206 and an associated interface that permits a user (e.g., an application designer or administrator) to design data-driven applications, modify application settings, permissions, etc. associated with database applications 207. Thus, server 202 may serve as a conduit to databases, application servers, business systems, etc. for a client, allowing distributed applications to be developed and used by permanent and occasionally-connected systems.

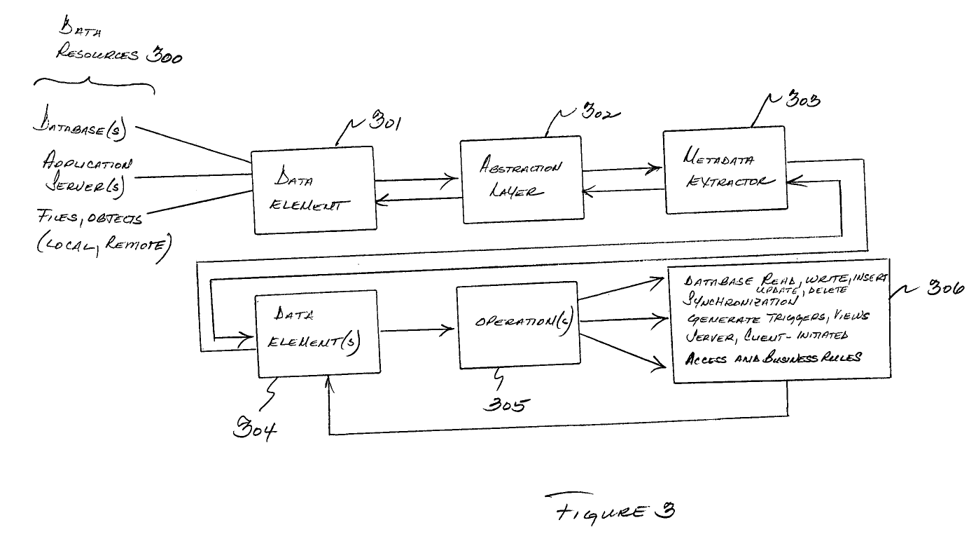

FIG. 3 shows an example dataflow within a system such as example system 200. As shown, system 200 may include one or more data resources that can be used by a distributed application. For example, these resources may include one or more databases, applications hosted on application servers, or other files, database objects or data entities that could be located in any portion of the distributed computing system. For instance, these data files and objects may be located in one or more servers located throughout the network or may be located locally to a client system. According to one embodiment, a method may be provided to allow access to any of these data sources within any given distributed application.

A data element 301 associated with one or more of these data resources 300 may be associated with a particular distributed application. According to one embodiment, data is abstracted through an abstraction layer 302. Because data is abstracted from the distributed system, different data sources can be substituted easily without breaking the distributed application. Abstraction layer 302 may include an identification component that uniquely identifies each data element in the distributed system. Such identification information may be used to identify the data element in a database. Such a database may be stored at a server (e.g., server 202) and presented to a client in the form of a database entry.

According to one embodiment, the system may include what is referred herein as a metadata extractor 303 that extracts information relating to the data element. In one embodiment, the metadata extractor may inspect data associated with a data element and store such metadata in the database. Metadata itself may be used in one or more applications, may be synchronized between systems, and may be used for any other purpose within the distributed application.

One or more data elements and/or metadata associated with such data elements may be then transferred to a client system where one or more operations associated with a disturbed application may be performed. According to one embodiment, the application is a data-driven application that permits a user to perform operations on a database. For instance, the application may perform database reads, writes, inserts, updates, and delete actions. Further, an application designer may define rules that define when data elements are synchronized between a client and the server, database triggers that are stored in the database and are executed when a database table is modified. For instance, triggers may be defined that cause a trigger to cause an action to occur when a particular occurrence happens.

Further, an administrator may define a number of application views that show data to a user. Further, database operations may be subject to one or more access permissions and/or business rules that define how information may be accessed within a database table. Synchronization rules may also be provided that determine when data that is synchronized between a client and server and such synchronization rules may depend on user permissions and/or business rules.

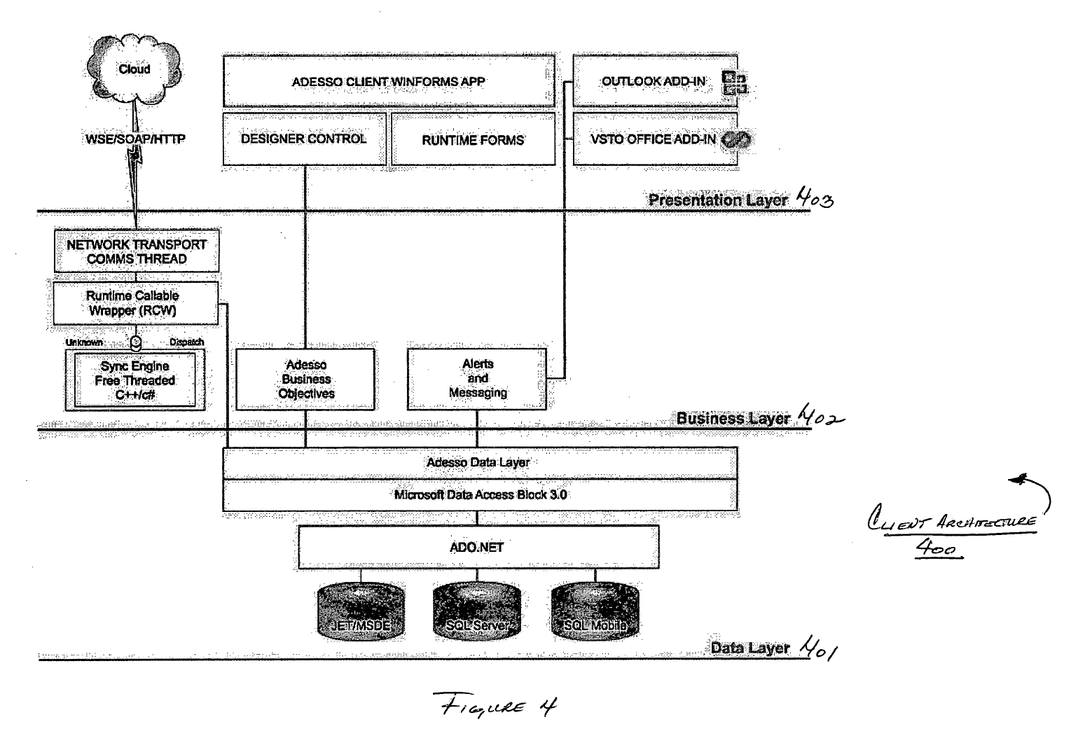

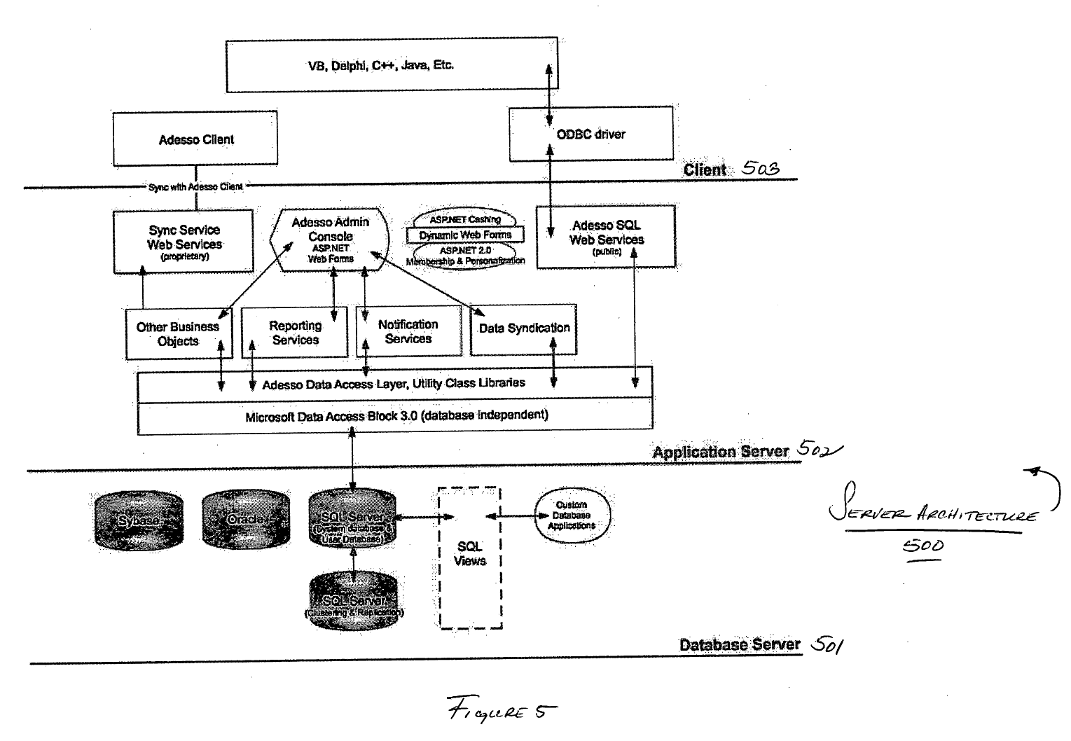

Although various aspects of the present invention may be practiced using a system architecture as shown generally in FIG. 2, it should be appreciated that various aspects of the present invention may be practiced with other architecture types. According to one specific embodiment of the present invention, various aspects of the invention may be implemented in the Adesso application platform. The Adesso platform is a rapid application development (RAD) programming tool which allows user to create a fully-functional database driven application. FIGS. 4 and 5 show client and server architectures, respectively, of the Adesso platform according to one embodiment of the present invention. Such client and server architectures may be similar in architecture to server 202 and client 201 of system 200.

Adesso client's application designer allows any non-technical user easily create database tables, forms, views and reports. When an application is created, the application can be used locally to store data also in conjunction with an Adesso Server, the application can be uploaded to the server and shared with other users.

As shown in FIG. 4, client architecture 400 includes a number of layers including a data layer 401, business layer 402 and presentation layer 403. Data layer 401 includes the databases and database access components used to access such data. Further, as discussed above, data stored in the database may be abstracted through an abstraction layer that uniquely defines data elements stored in the database. Such data elements are presented to a business layer 402 in which various rules define how such data elements are synchronized, accessed, and displayed to a user. For example, such rules may include application setting that reflect business objectives and rules that define when data is synchronized with other systems. The client may include a presentation layer which defines interfaces through which data may be viewed (e.g., forms, application, etc.) and designer interfaces for designing distributed applications.

FIG. 5 shows one example of a server architecture 500 that may be used to implement various aspects of the present invention. Architecture 500 includes a database server layer which includes one or more databases (e.g., SQL Server, Oracle, Sybase, or other type of database) and any database applications. Application server layer 502 includes any data access components used to access such databases and elements used to define the distributed application which use such data. As discussed above, a synchronization engine of the application communicates with a synchronization engine of a client to transfer data from the databases to one or more client applications. Further, a client layer 503 may include its own database access components that may be used to access databases either locally or remotely through application server layer 502.

An Adesso Server includes two major components, a component referred to as the Administration Console and a component called Synchronization Web Services. The Administration Console is a web based administration environment which allows user to view and manage Adesso Accounts and Applications. The Administration Console also allows administrator to perform high level administrative tasks such as creating synchronization links (SyncLink), uploading user information, obtaining activity reports, etc.

Adesso Synchronization Web Services includes a set of web methods based on web services standard used by an Adesso client to synchronize applications (upload/download design and data records). When an application is uploaded to the server, there are a number of different settings that the application manager can apply on the application and users of that application. Some of these settings include, for example:
Access Control: allows a manager to set each user/group access to each table at a database field level. Using this feature, a manager can control which fields of each table and which views are accessible by users and what is the access level (read-only, ability to modify fields and/or add/delete records
Content Control: A collection of different settings including synchronization filters, synchronization direction and CRM (conflict resolution mode) that controls which records of each table can be accessed by each user/group. Using synchronization filters it is possible to control access to contents of one table based on the contents of other tables. Also, user parameters (current user's name, email address, etc.) may be used in the filters to control contents based on who is synching with the application.
Synchronization Order: Ability to determine in what order tables can be synced. This feature is especially important when synchronization filters are used and contents of one table relates to another table.
SyncLink: Ability to link an Adesso application directly to an external database (e.g., an SQL Server database) table in order to integrate with existing legacy data. The linked table appears as a regular database table within the distributed application (referred to as an Adesso table).

Various aspects of the invention may be implemented, for example, using any of the architectures shown in FIGS. 2, 4 and 5. Such architectures are shown by way of example only, and it should be appreciated that various aspects of the present invention are not limited to the particular architectures shown. Below are examples of a system that may utilize an Adesso platform to transfer data (data, files, etc.) to be used by an Adesso application. However, it should be appreciated that various aspects of the present invention may be used with other operating systems, applications, and platforms.

Synchronization Engine

According to one embodiment of the present invention, a synchronization engine (e.g., synchronization engine 211) is provided that permits synchronization of applications and associated data between two or more entities. In one embodiment, the synchronization engine may be provided as part of the Adesso platform (e.g., in an Adesso Enterprise Server), allowing real-time access to tables within other databases (e.g., SQL Server databases) through the Adesso platform.

Using this feature (referred to herein as SyncLink), an administrator can link an existing database table to an Adesso application (described by a database table referred to herein as an Adesso table) and share that table among application users. This table appears as a regular Adesso table and any user that is permitted to design applications (e.g., a user having a “Designer” permission) can create Forms, Views, Filters and Reports associated with that table. The table also can participate in Relationships with other existing tables defined in the Adesso platform.

After creating the link, users'access to the linked table contents also can be controlled via Adesso's Access Control and Content Control mechanism which allows an administrator to determine what portion of a data record may be accessed by each user. By establishing a link to an external table, any change on that external table including new, updated or deleted records are reflected directly in the Adesso application. Depending on how the link is setup by the administrator, changes from the Adesso application are applied to the external table in real-time.

According to one embodiment, a synchronization engine is provided that permits an easy and efficient method for linking applications to existing data (e.g., in conventional database systems and application servers) and for managing that data from an client (e.g., an Adesso client).

According to one aspect of the present invention, a capability is provided that enables information contained in managed databases to be repurposed for use in devices that otherwise have no access or connection to the database(s). This is accomplished, according to one specific embodiment, by a) using no existing software from the original database system, b) maintaining strict relational and semantic integrity, c) no modification to the data schema (other than the use of database triggers), and d) requires no additional software be installed at the database server. This may be accomplished, for instance, by the dynamic generation of code (e.g., a new trigger and database view), based on the analysis of metadata that the database is inherently capable of providing and constrained by the administrator who configures the synchronization engine.

According to one embodiment, a capability is provided to “unlock” existing enterprise data and information assets without the need to modify the database schema, install additional software at the database server (beyond the Adesso server software and data access components), or to design and implement custom middleware.

The “traditional” way of exposing these types of data assets may include, for example, encapsulating them in object-oriented middleware layer and then building a custom web service so that one or more remote clients could access these objects. In addition, the traditional approach requires that custom client software be written in order to communicate with the custom web service. In the traditional way, controlling of users'access to existing data requires a complex-programming with hard coded, logic which is not easily modifiable and maintainable. According to one embodiment, a system is provided that uses existing database features, interfaces and capabilities in combination with Adesso Server technology to access such enterprise data.

A connection using a synchronization engine using a synchronization protocol can be created, for example, by an administrator of an Adesso system in few easy steps. For instance, in a SyncLink configuration web page, an administrator may select a source database (e.g., an SQL Server database), a table within that database. Further, the administrator then selects an Adesso account and application on that server which needs to be linked. As the next step, the fields from the source table are selected to import.

Then the type of the link may be selected. The types of links may include, for example, Insert, Update and Delete links. These link types determine the level of interaction between Adesso server and the source table. By establishing a link to an existing table, depends on how the link is setup, Adesso Server creates a “partial” Adesso user table, a SQL view and several triggers on both the source table (existing table which is linked to Adesso) and an Adesso table.

In one example, triggers are responsible for keeping source and Adesso table in sync and the view joins source and Adesso table and presents them as one unified Adesso table. During the synchronization with an Adesso client, the server reads and writes to the SQL view just like an ordinary Adesso table and triggers are used to maintain the integrity of tables.

A synchronization engine may be, for example, based on a combination of database (e.g., SQL Server) capabilities and Adesso Server components. In one example, a synchronization engine and associated components may be adapted to dynamically query a database's metadata and generate database components such as triggers and views. SyncLink may, according to one embodiment, be built using Adesso Server components, the Adesso database structure, Adesso's Access Control and Content Control and Adesso's intelligent synchronization components.

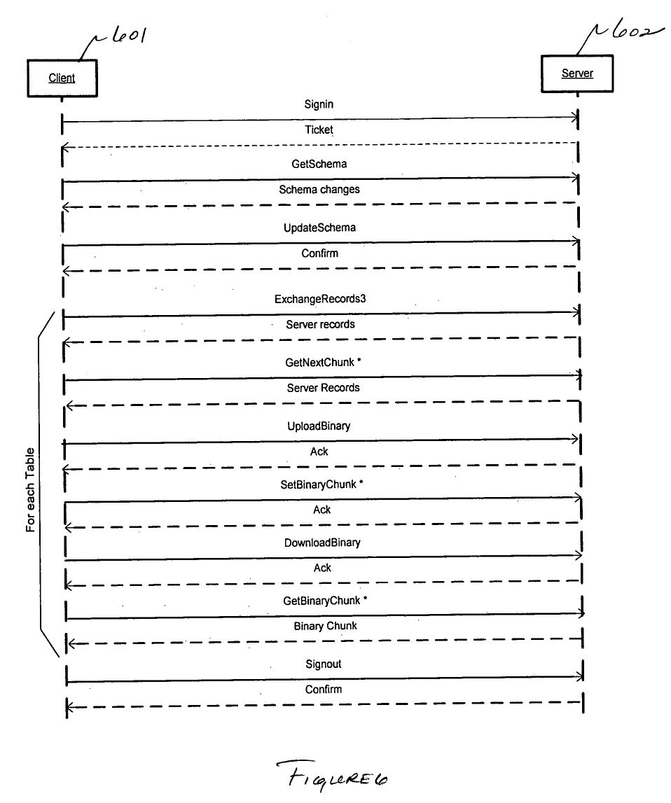

FIG. 6 shows an example synchronization process according to one embodiment of the present invention. In particular, FIG. 6 shows a client 601 in server 602 that function to synchronize one or more data entities (e.g., database entries, files, etc.) as part of a distributed application. The process begins with a client signing into a server, and once authenticated, the client (client 601) requests a copy of the database schema and any changes are transferred back to the client.

If the client changes one or more database records, the client sends any updates to the server, the server applies the updates, and confirms the update with the client. According to one embodiment, a capability is provided for client to selectively upload and/or download file or other types of data. As is shown in FIG. 6, a method referred to as “ExchangeRecords3” is provided that allows data such as files and binary data to be transferred selectively between the client and the server. One problem with traditional synchronization engines includes a limitation on the size of the file that can be transferred in a synchronization action. According to one embodiment, if the size of a message sent by a client is larger than a “chunk size”, the client calls the method multiple times to exchange further data chunks. The server then sends any server-size changes back to the client. If a server message is larger than the chunk size, the method returns only the first chunk, and then the client calls a further method (e.g., GetNextChunk) to get the rest of the message. Traditionally, if a file exceeded a particular file limitation size, only a portion of the file would be sent to the client or the file would be skipped altogether.

The client starts uploading each binary by calling a method referred to as UploadBinary which indicates to the server to be ready to receive a large binary for a specific record and field, and then the client executes a method referred to as SetBinaryChunk uploads the binary data to the server. Depending on the size of the binary and chunk size, a client might call the method SetBinaryChunk multiple times. Once the last part the binary is uploaded, the server starts the process and puts the binary in the requested field, overwriting whatever data is currently in the filed.

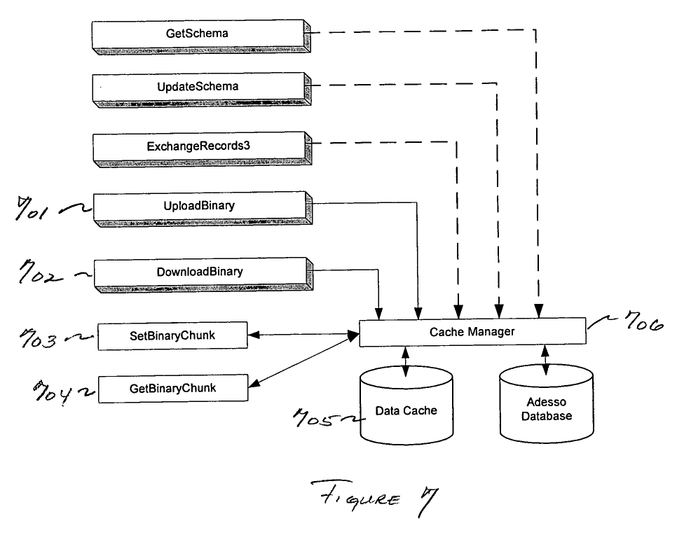

A client may download each large binary by calling a method referred to as download binary first and then a method called GetBinaryChunk. The method download binary indicates to the server to prepare a large binary from a specific record and field to download to the client, and the method GetBinaryChunk downloads the binary data from the server. Depending on the size of the binary and the chunk size, a client might call GetBinaryChunk multiple times. Once the last part of the binary is downloaded, the client starts the process and appends the binary to the requested field. In summary, a protocol is provided that addresses the skipping of large records, and provides a capability of client-size on-demand binary download. Further, as discussed below with respect to FIG. 7, because a cached binary is kept on the server and the client, the client is permitted to resume the upload/download operation in a following synchronization.

FIG. 7 shows a server synchronization engine according to one embodiment of the present invention. In particular, there may be provided a number of methods that are executed by a server to initiate and accept the transfer of binary data. In addition to the get schema, update schema, ExchangeRecords 3 methods as described above with respect to the client, the server may include a method upload binary 701 which prepares the server to accept a large binary by informing a cache manager 706.

A method download binary 702 is provided which prepares the server to cache and send a large binary by informing the cache manager. Further, a method GetBinaryChunk is provided that sends one chunk of cached binary data to the client. Further, a method called SetBinaryChunk accepts one chunk of cached binary data from the client.

The cache manager 706 is responsible for keeping track of each cache binary, calling the correct process after the data transfer is completed in managing data cache 705.

According to one embodiment, the SetBinaryChunk and GetBinaryChunk are two generic methods that perform functions of uploading and downloading chunks of binary data, no matter what kind of data is being exchanged. Because of this, such methods may be used to transfer schema and data records (e.g., such as performed by the GetSchema, UpdateSchema, and ExchangeRecords 3 functions). Thus, such methods may permit different types of clients with different transfer methods such as streaming, FTP, and BITS (Binary Intelligent Transport Service) by providing different versions of the GetBinaryChunk and SetBinaryChunk methods.

Cache manager 706 may use an SQL server table to store uploaded chunks as well as tracking caching requests. Further, stored procedures may be provided to read and write to such a table.

Application Server Data Access

As discussed, a capability may be provided for allowing occasionally-connected or permanently-connected systems to share an access content with an application server or system. Access to such an application server system may be desired to extend the application to one or more clients. According to one embodiment, data provided through a standard interface of an application server is analyzed to determine application metadata. The metadata is used to determine application data and functionality, and such metadata is stored in a database and made available to clients to perform application functions. In this way, functionality of the application server may be extended easily to clients. In one example, the application server may be a collaboration management server such as the well-known SharePoint that provides the ability to share files and other content among Microsoft Windows clients (e.g., PCs). According to one embodiment, access to the SharePoint system is provided to other types of clients through an Adesso system.

This access feature may be provided, for example, as a feature in an Adesso Server which allows information in a SharePoint server to be accessed by an occasionally-connected client. According to one embodiment of the present invention, the following capabilities may be provided:

a) The ability to install dynamic triggers into an existing SharePoint database. Installation is performed by using a configuration page provided within an Adesso Management Server. The configuration page permits the user select the particular SharePoint application, the particular list, and the specific fields that are to be “mobilized”. In addition, the web form may allow the administrator to configure what types of operations are to be allowed (e.g. insert, update, delete). Once this step is performed, dynamically-generated triggers are installed in the target database and the corresponding “wrapping” table is created in the target Adesso application into which this table has been made accessible.

b) The ability to transact locally (i.e. not against the master database) while not directly connected to the SharePoint portal. All local transactions occur within the control of either the Adesso Client or via the AdessoSQL ODBC driver (which could be used by 3^{rd} party ISVs who are customers of Adesso and have licensed the AdessoSQL ODBC driver). By using the AdessoSQL driver, 3^{rd} parties can create their own, custom branded interface on a particular edge device. The extra cost incurred by an ISV is that they would need to create applications for each specific platform that they want to support. By contrast, if the Adesso Client is used to access SharePoint data according to one embodiment of the invention, native support the “mobilized” SharePoint applications is provided on all platforms (including non-supported operating systems and platforms by the Microsoft SharePoint system) that are supported by an Adesso client.

Updates may be communicated, for example, via a synchronization engine. Updates at the server may be performed during the process of synchronization. While the server-side aspect of the described functionality could be duplicated—doing so would also involve developing client-side capabilities of the Adesso platform as well as a web service or similar communication channel that allowed the client and the server to synchronize with each other. In this manner, additional development effort in supporting additional clients is reduced. However, it should be appreciated that a specialized web service or other communication channel may be provided that permits access to a SharePoint application server.

SharePoint.NOW is a new feature in Adesso Enterprise Server which allows real-time access to the information managed by a SharePoint enterprise portal. Access can occur from any device that Adesso supports (PDA, phone, laptop, desktop) in a complete “offline” model—as opposed to the real time through a browser model of the SharePoint portal.

Using this feature the administrator can link an existing SharePoint application (referred to as a List in SharePoint) to an Adesso application. This application appears as a regular Adesso table and any user with the Designer permission can create forms, views, filters and reports on that table. Further, the SharePoint application functionality may be extended by permitting the SharePoint application table to participate in Relationships with other Adesso tables.

User tables in Adesso, referred herein as Adesso tables, are stored in two parts; schema and data records. In this essence Adesso's use of database tables is “untraditional” in a number of ways:
1. Adesso's approach to managing applications is to create an abstracted metadata model of the application. The metadata represents underlying data schemas for each table in the application, the definitions of the views and forms associated with those tables, the access control rules, and synchronization rules.
2. The client (and similar logic on the server) allows a designer (e.g., using the Adesso application designer program) to subsequently “re-design” the application, as needed. Because the application is serialized to the database in a way such that the application and data is abstracted, the platform can support dynamic re-design of the application and data without loss of data. This is something that cannot be achieved with traditional database tools and designers because they depend on code generation that is subsequently customized by a developer. Once that code is generated, if the underlying database schema is changed (a process inherent to various aspects of the invention) the originally generated code has to be thrown away and regenerated and any other algorithms that were written or applied to the original data schema have to be modified to support the new schema.
User's data records may be stored in a dynamically-created database table. The fields in these tables include user defined fields (stored with an internal abstracted name) and few fields used by the system to track changes and ownership of each data record.

The SharePoint application may be mapped into an Adesso table by creating the appropriate metadata to represent the table in the context of an Adesso application. This metadata also includes “cues” or “hints” that the Adesso client may use to prevent the designer from modifying the schema at the “edge” with the Adesso designer. Dynamic redesign should be prevented because the target database (the SharePoint database) is not modifyable by the Adesso platform. Rather, the target database is stored in raw form with no abstraction model as provided by Adesso for its natively-managed tables.

By establishing a link to an external application, any change on that application including new, updated or deleted records is reflected directly in the Adesso application and depends on how this link is setup, changes from Adesso are applied to the SharePoint application data.

According to one embodiment, the access to application server data may depend in large part on a synchronization engine and protocol and has explicit knowledge (available through public web service interfaces that are documented and supported by Microsoft) of some of the inner workings of the SharePoint application server. This knowledge may be used to improve the user's experience in working with the offline application. According to one embodiment, an easy and efficient way may be provided for linking Adesso applications to SharePoint data and for managing that data from an Adesso client.

According to one aspect of the invention, an ability is provided to “mobilize” existing enterprise portal data and information assets (e.g., as provided by a SharePoint server) without the need to modify the database schema, install additional software at the database server (beyond Adesso's software), to design and implement custom middleware. Most importantly, it allows users to work with SharePoint in an occasionally-connected model, i.e. when they have no permanent connection to the network that provides access to the enterprise portal.

One “traditional” way of exposing these types of data assets may include encapsulating them in object-oriented middleware layer and then to build a custom web service so that a remote client(s) could access these objects. In addition, the traditional approach would then require that custom client software be written in order to communicate with the custom web service and that the client software invent some way of performing conflict resolution. In general, the cost of doing all of the necessary steps in order to ensure that transactional and semantic integrity of the backing database is prohibitive unless a developer has a system such as Adesso with its rich client and SyncLink technologies available.

According to one embodiment, Adesso software components may be co-located with the SharePoint server—i.e. the Adesso native databases are resident in the same SQL Server database cluster as the target SharePoint server.

According to one embodiment of the invention, knowledge of how SharePoint represents some of its metadata is provided to a server system (e.g., an Adesso server) and access is provided to clients through the server system). For example, the SharePoint system stores in a special table a “pretty name” for a table. Adesso needs to know what this pretty name is in order for the application name to make sense to the user. As an example, a SharePoint system might name an “Events” table “ows₁₃ 5656464564_events”. Adesso reads the SharePoint metadata to determine that the table should actually be named “Events” in the user interface.

One aspect of the present invention relates to mapping the metadata from a SharePoint system-dependent form to a user-accessible form for use within the Adesso platform. In one embodiment, capability of a synchronization engine may be extended to have specific knowledge of SharePoint internal metadata. This may be done, for example, to improve the user experience in working with the SharePoint application.

According to one embodiment, such functionality may be provided as a new feature (referred to herein as SharePoint.NOW) in an Adesso Enterprise Server thereby allowing real-time, disconnected access to SharePoint applications. Such a feature may operate to:
a) Enhance the generic data synchronization technology with explicit knowledge of SharePoint's meta-data semantics. For example, SharePoint (like Adesso) utilizes an data-abstraction model that results in internal SharePoint tables to have names that are “GUID” and whose internal names are never presented to the end user.
SharePoint.NOW uses public web service interfaces supported by Microsoft to resolve this discrepancy (as opposed to having reverse engineered the actual database internal structure that is used as a backing store for a SharePoint portal.
b) Providing a custom non-repudiable audit trail capability that is made visible (if configured) as a SharePoint application in order for a SharePoint administrator to track and trace activity that occurs at the edge in Adesso rich clients.
c) According to another aspect of the present invention, non-repudiable audit trails may be provided for data stored in the Adesso platform. Without the SharePoint.NOW functionality, these secured audit trails may be accessible only through the Adesso Management Server's administration pages. With the SharePoint.NOW functionality, these audit trails are made accessible natively within the SharePoint environment by dynamically generating a SharePoint application and populating that application with audit trail events which SharePoint itself has a native ability to craft a user interface for.

Groove Networks includes a commercial product referred to as a “Mobile Workspace for SharePoint” that is co-marketed by Microsoft and Groove. The Groove solution is implemented as pure client-side technology and installs no software on the server that the SharePoint portal is installed in. Furthermore, the Groove solution does not use the official web service as documented by Microsoft, as the service was not available at the time of the implementation. In addition, the Groove solution provides no ability for the individual users that are sharing the offline SharePoint portal to update the portal directly—all updates must be coordinated through a single offline user through a hub-and-spoke model at the “edge” of the network as opposed to the natural hub-and-spoke model of enterprise portal.

In summary, the Groove solution is an outside-in approach driven by Groove's internal architecture and operating approach, whereas one embodiment of the invention relates to a system that uses an inside-out approach driven by the “classic” architecture of an enterprise portal (e.g., SharePoint) and as such could be extended to virtually any enterprise portal product available on the market.

The main difference with the Groove approach is that installs no additional software at the server—the Groove approach is a “pure” web services approach that pulls from SharePoint meta-data and underlying data, dynamically generates applications that run within Groove, and then pushes any changes back from the edge into the central “master” SharePoint database. The party that initiates the “pull” of the SharePoint application is the only one that can synchronize changes back to the master. Because of this design approach, most changes to SharePoint are made “on behalf of” somebody else—this is sometimes referred to as “delegation.”

With the Adesso approach according to one embodiment of the invention, data is “pushed” from the center to an adjacent hub (Adesso) and normal Adesso functionality is then utilized. Any user who has been granted access to the Adesso application is capable of synchronizing changes directly to the Adesso/SharePoint server.

File Synchronization and Sharing

According to one embodiment of the present invention, a file synchronization and sharing capability may be provided in a client-server system (e.g., an Adesso Enterprise Server and an Adesso Client) which allows users of a distributed application to share files at the client's file system level as part of their collaboration/business process automation tasks that they conduct.

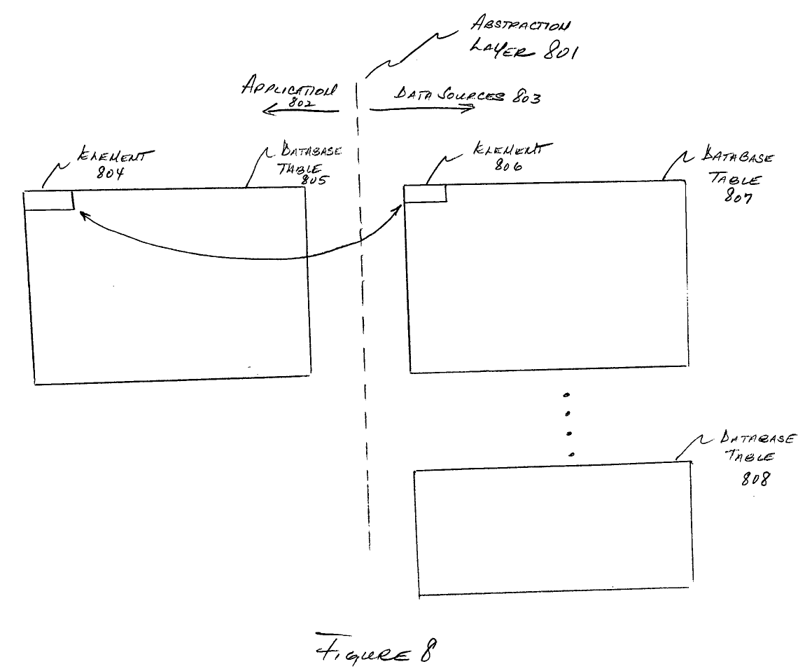

FIG. 8 shows an example relation through an abstraction layer according to one embodiment of the present invention. In particular, an abstraction layer 801 is used to isolate data used by an application 802 (e.g., a distributed application) from data stored in one or more data sources 803. For example, data sources 803 may be any data source, such as a database or file located on the server or client or any location in a distributed network.

An application 802 includes a database table 805 having at least one database element 804. According to one embodiment, the abstraction layer 801 maps the element 804 to an element 806 in for example a database 807. Direct access of data element 806 is according to one embodiment not permitted from application 802 such that if the underlying data element 806 has changed, the application 802 is not “broken.” According to one embodiment, an abstraction layer 801 provides a unique identification through which elements may be abstracted. Because data is abstracted in this manner, data from multiple sources (e.g., database table 807, 808, etc.) may be used to provide data to a single application 802.

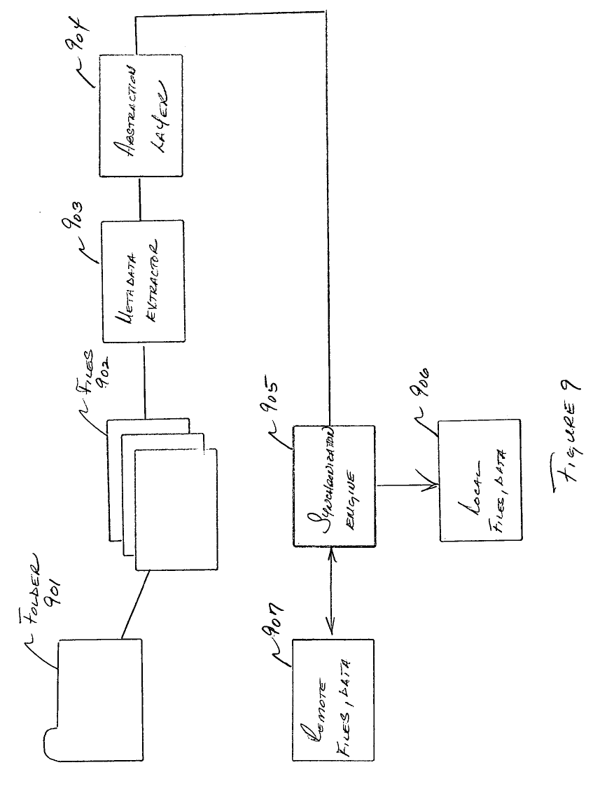

As discussed above, various aspects of the present invention relate to transferring and sharing content (e.g., in the form of files) between systems. FIG. 9 shows an example data flow in the system according to one embodiment of the present invention. In particular, within a client system, a container-based organizational system may be defined for organizing and presenting data to a user. In particular, the client may include one or more defined containers such as folders 901 that contain one or more references to data. These references may be, for example, representation of files 902, that when acted on by a user in a user interface may cause an action to be performed with the data. According to one embodiment, such data may include the file data 902.

As discussed above, a system may be provided for sharing file data of multiple types. To this end, a metadata extractor 903 may be provided that analysis data (e.g., files) and permits the extraction of metadata for use in a distributed application. The client may include one or more programs that perform data extraction from various data types (e.g., different file types) and store such data in a distributed database.

As discussed above, an abstraction layer 904 may be used to abstract data elements referenced within an application with data elements associated with various data sources. The system may include one or more synchronization engines 905 that, based on actions performed by a user in a user interface of a client, cause either the uploading or downloading of file data to one or more various sources. Such sources may be, for example, local to the client in the form of local files and data 906. Further, the synchronization engine may have access to remote files and data 907 located on one or more remote data sources. Thus, a client may be adapted to access both local and remote file data through a data driven distributed application.

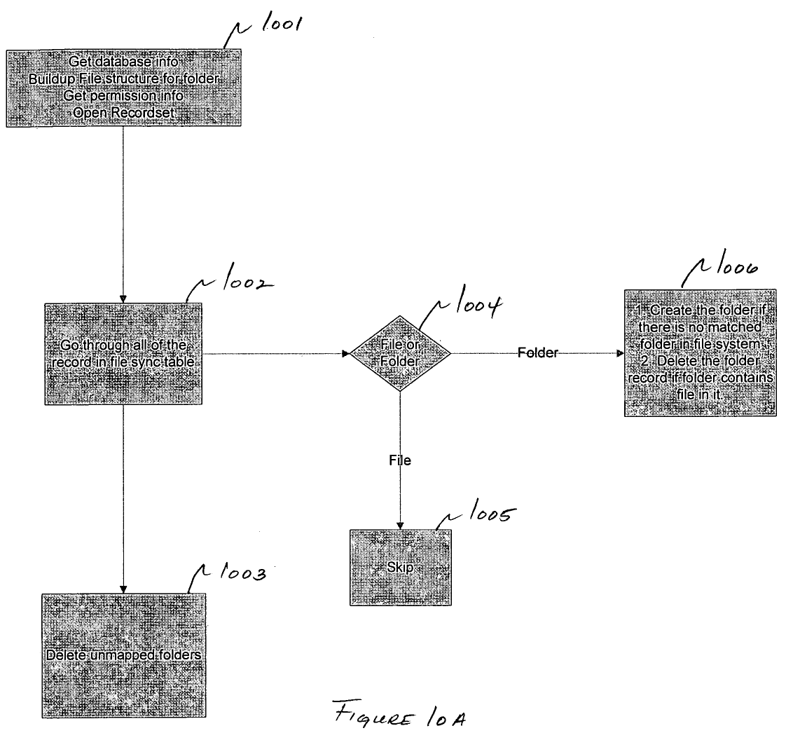

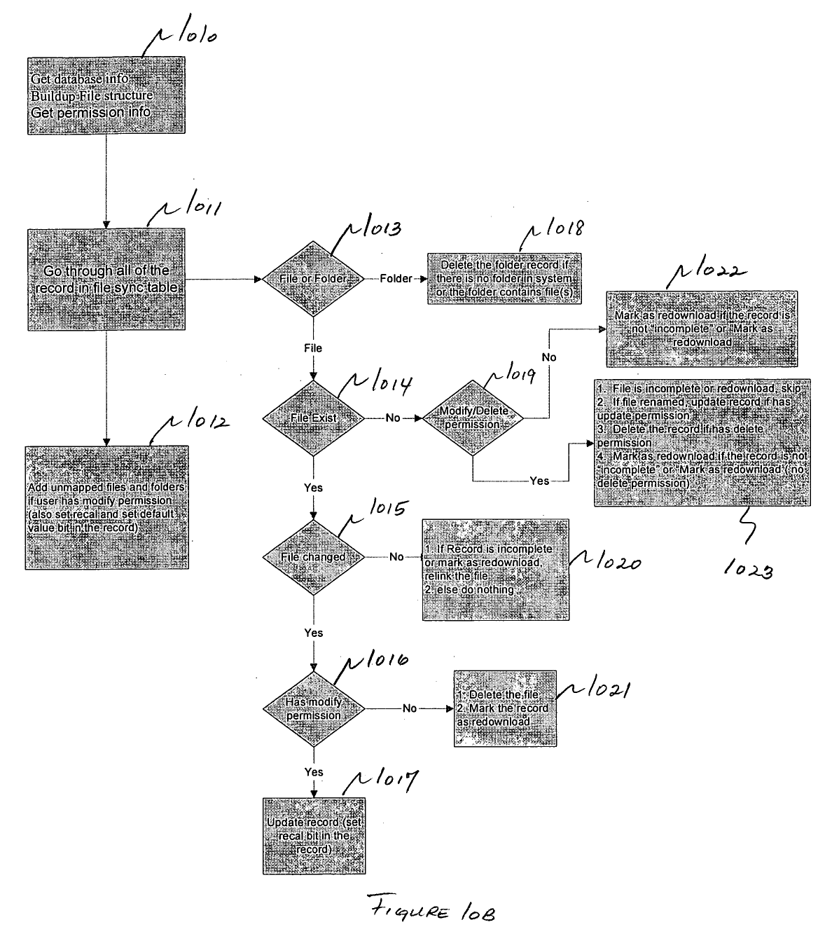

According to one embodiment of the present invention, a method is provided for linking files among systems. FIG. 10A shows one example process for synchronizing local files with a distributed application. At block 1001, the client retrieves database information relating to the files and any file structure information for the associated container (e.g., folder). Further, any permissions are retrieved along with any associated database records in a table tracking files that are linked (e.g., a file synchronization table).

At block 1002, a process (e.g., a synchronization process) inspects records of the file synchronization table. At block 1003, all unmapped folders are deleted from the local file system. That is, if there is no mapping (or a mapping has been discontinued) the files associated with the mapping are deleted from the local file system of the client. At block 1004, it is determined whether the database entry relates to a file or a folder. If the entry is a file, the file is skipped at block 1005. If the entry is a folder, a folder is created if there is no previously-existing (matched) folder defined on the client (e.g., in a file system of the client) at block 1006. If a folder contains a file in the folder, the folder record is deleted.

FIG. 10B shows one example process for synchronizing local folders with a distributed application. At block 1010, the client retrieves database information relating to the folder and any file structure information for the associated folder. Further, any permissions are retrieved along with any associated database records in a table tracking files that are linked (e.g., a file synchronization table).

At block 1011, a process inspects records of the file synchronization table. At block 1012, all unmapped folders are added if the user is provided a modify permission. That is, if the user has modification rights, a mapping is added to permit the user to access the appropriate folders and content. At block 1013, it is determined whether the database entry relates to a file or a folder. If the entry is a folder, the folder record is deleted if there is no folder in the system or the folder contains one or more files. If the database entry relates to a file, it is determined at block 1014 whether the file exists.

If so, it is determined whether the modify/delete permissions for the file have changed at block 1019. If not, the file entry is marked for redownload if the record is not incomplete or otherwise indicated as needing to be redownloaded. If the modify/delete permissions for the file was modified, one or more actions are performed at block 1023. In particular, if the file is incomplete or indicated for redownload, the file entry is skipped. If the file is renamed, the record is updated if the user has update permissions. The record may be deleted if the user has delete permissions. If the user has no delete permissions, the file entry is marked for redownload.

At block 1015, it is determined whether the file was changed. If not, one or more actions may be performed at block 1020. If the record is incomplete or otherwise indicated as marked for redownload, the file is relinked. Otherwise, the process takes no action. If the file was changed, it is determined at block 1016 whether the user has modify permission on the file. If not, the file is deleted at block 1021, and the file entry is marked for redownload. If the client has modify permissions, the record is updated at block 1017.

One application using such technology includes the capability of publishing to and subscribing to various files. Thus, a content distribution system may utilize various aspects of the present invention for transferring media files from one location to another using such a publish/subscribe method.

In one specific embodiment using the Adesso platform, by allowing the management and distribution and sharing of files at the file-system level, the user is empowered to work outside of the Adesso user interface and to leverage the synchronization and data management capabilities.

By default, users apart from the originating user (i.e. the user that creates the file) will not receive the file—an optimization targeted at the low-storage, low-bandwidth available on a typical Windows Mobile device.

According to one embodiment, the file being shared is located in the originating user's file system. A copy is also securely stored in an encrypted format at the server (either within the Adesso database or on the Adesso Management Server's file system). For each additional user of the application that has the file sharing capability enabled within it, the file will be stored on that user's hard disk natively (unencrypted) only if that user subscribes to that file. Regardless of the subscription, the user will have the appropriate metadata to be able to determine the state of the file.

According to one embodiment, a “shell extension” is part of the solution such that the file will “appear” to be local from the user's perspective if they browse or search their local hard disk. A shell extension is an existing, documented, supported API from Microsoft that lets 3^{rd} parties customize the desktop/explorer of Windows to behave in this customized manner.

Because of the existing capabilities of the Adesso Enterprise Server (specifically the AdessoSQL web service), additional integration can occur into other enterprise business systems (ERP, CRM, SFA, etc).

According to one aspect implemented in the Adesso platform, the file sharing and linking feature (referred to herein as the Files.Now feature) provides the capability to share files of any type or size among users who are sharing an Adesso application.

Services such as this are typically part of a core operating system. As a result, the ability to do “partial sharing” becomes a very difficult if not impossible solution to support in a generic manner. For example, Microsoft's WinFS technology has been delayed numerous times because of the difficulties of implementing this type of technology in a general-purpose usage scenario.

The Adesso approach differs from conventional file sharing technologies principally because the file sharing features are built, according to one embodiment, exclusively on the Adesso infrastructure. This approach brings the context of the file sharing into a business process automation task. Other traditional file sharing systems (e.g., Napster-like systems such as WinMX, BizTorrent, KaZaa, etc.) do not provide the sharing of documents in a collaborative setting including roles, responsibilities, and access control are desired. According to one embodiment, a capability is provided to share documents as part of a collaboration/business process automation tasks where access control, roles, responsibilities, etc. are critical due to the nature of the documents being shared.

According to one embodiment of the invention, the file sharing and linking function may be provided as a new feature in file sharing and linking a client and server system (e.g., in the Adesso Enterprise Server and the Adesso clients). According to one embodiment, components may be provided that:

Allowing the administrator to define the name and location of a folder. Files in sub-folders of the root folder will not be synchronized or made available for subscriptions.

Taking a “snapshot” of the files that are in a folder and creating a proprietary meta-data record for each file. As part of the snapshot, the traditional file meta-data will be augmented with Adesso specific information that utilizes industry standard cryptographic technique of computing a one-way hash that concisely represents the state of the file. This hash value is not intended to provide security—but it does provide a guaranteed mechanism by which changes to a file can be identified as well as a means to detect that a file in a particular folder has been renamed. The hash value may be, for example, a one-way has of the entire data in the file. Although the computation of this hash value can be costly for extremely large files (>1 GB) but for typical business documents (<2 MB) it can be computed in milliseconds.

Performing a periodic polling operation (as opposed to installing an operating system-level hook) that creates a new set of meta-data records and reconciles any changes that may have occurred to files that were previously identified in early polling steps.

The polling operation is performed automatically by Adesso as part of its native synchronization process.

Implementation of a custom server-side web-service “FileSync.NOW” that is capable of allowing a client to either i) subscribe to a specific file that is under management and/or ii) retrieve the file on an on-demand basis. The FileSync.NOW service may, according to one embodiment, support secure delivery with recovery capabilities. Specifically, the FileSync.NOW capability may operate in parallel to the existing Adesso synchronization engine capabilities that are optimized for synchronizing at the field level of a database record.

Current file synchronization capability includes storing a file in a field of an Adesso database record and therefore files are synchronizable as part of the current synchronization process. The FileSync.NOW service may, according to one embodiment of the invention, “chunk” files at a small, device-optimized and packet network-optimized size so as to avoid “locking up” device while a background FileSync.NOW process is operating.

In one embodiment, the Files.NOW and FileSync.NOW may include the following components:
i) a Folder Manager component that is responsible for creating and managing the cache of file-level meta-data
ii) a modified Adesso designer that allows the inclusion of the file sharing folder as part of the application
iii) a FileSync web service method extension that is capable of“chunking a file” for background download/upload with recovery. Recovery is important because of the “occasionally connected model” it may be desired to transmit over the “wire” a few bits as necessary to move the file from one device to another particularly in the world of unreliable or broken connections.

Microsoft has a variety of technologies that allow one to “share files” —but the Microsoft approach is limited to the notion of a centralized shared resource—the solution does not distribute and synchronize either file metadata and/or the file contents themselves.

Groove Networks has a technology referred to as “Shared Files Workspace”. The Groove solution involves deep integration with the Windows Shell (Explorer) and allows a user not only to share files but also to have discussions and chats about the “workspace” that the file sharing is a part of Groove's implementation also involves double-storage, i.e. for each file that is part of a file sharing workspace, they create a duplicate copy of that file that is encrypted and stored in some other portion of the local users hard-disk. Furthermore, the Groove Networks solution is designed to work with traditional always-connected clients (e.g., Windows 2000 and Windows XP). However, the Groove implementation does not work on occasionally-connected systems (e.g., Windows CE/Windows Mobile devices).

An approach according to one embodiment of the invention may work on any operating/file system, including those occasionally-connected systems where an Adesso client is supported. Such an approach works, at least in part, because the FolderManager takes responsibility for managing the metadata cache (stored within a normal Adesso table). Shared files are stored on the physical disk (outside of Adesso managed database tables). The designer of the application specifies that the application should include a Files.NOW capability and specifies the location of the folder (typically stored under the user's Adesso application data folder). If the designer indicates that all files should be synchronized, no additional steps are required by the user. If, however, the designer indicates that a publish/subscribe model should be utilized, then each individual user will use the Adesso user interface to subscribe to one or more particular files that they are interested in. Thereafter, all changes are handled automatically by Adesso during the course of normal Adesso synchronization operations.

Content Distribution

According to one embodiment of the present invention, a capability is provided for using a publish/subscribe model for distributing content among occasionally-connected devices. For instance, a group of users operating in a disconnected manner can publish and share content such as media files or other information.

A feature referred to herein as Content.NOW is a new feature (e.g., that may be provided in an Adesso Enterprise Server) which allows a publish/subscribe model to be applied to occasionally-connected devices. With the Content.NOW functionality, a group of users operating in disconnected manner can publish and share content channels. Content distributed over those channels can be any form of digital content. For example, content may be provided such as news, sports, music, video, etc, also location-based information such as restaurants, emergency services, Wi-Fi access points, etc. based on user location. Content.NOW technology may also enable a user to access to other type of on-demand data such as stock quotes, or weather forecast information.

Using this feature, a user subscribes to one or more content channels or selects a location on the Adesso client. After a synchronization operation is performed with the server, he/she receives the content/information for the selected channel/location. Using Adesso's SyncLink feature, contents can be retrieved directly from existing databases in real-time.

According to one embodiment of the invention, the Content.NOW technology depends upon Advanced Sync Rules, Audit and Content chunking technologies provided in the Adesso platform.

According to one embodiment of the invention, the ability is provided to “mobilize” new and existing digital content, location-based and on-demand information distribution into a disconnected environment and where that content can be shared, tracked, and traced among the group of users that share the content channels.

Content.NOW technology does not, according to one embodiment, provide a streaming or broadcast-like distribution medium, nor does it intend to address digital rights management (DRM) scenarios, although such implementations may be possible and are within the scope of the present invention. According to one embodiment, one Content.NOW technology approach includes a distribution of content for offline usage by an occasionally-connected system. Its use could be limited to a single user across various digital devices (e.g., phone, PDA, laptop, desktop, tablets, and the like).

The traditional way of delivering these types of digital data includes delivering them from a paid service such as Apples iTunes or Real Networks music services. While these are point-to-point services (where the starting point is the central Internet server and the end-point is the system to which the content is downloaded, e.g. an Apple iPod), they generally require an intermediate system (a computer) to perform the download operation. Rather, the Content.NOW capability may be performed between end systems.

According to one embodiment, Content.NOW technology is built upon the well-known Adesso platform technology and may be based on a publish/subscribe model. In this method, a special Adesso application may be provided that covers three major components; Channels, Contents and Subscription.

Channels include a description of available contents/services on the server. Contents are the actual digital contents/information delivered to the user and Subscription contains the selected channels/contents selected by the user.

Using Adesso's Advanced Sync Rules, Access Control and smart sync, each time a user syncs with the server, the newly selected contents may be downloaded to his/her client application and remain there for future disconnected access.

The contents on user's client application is controlled by his/her subscription to the accessible contents and is controlled by Adesso's Sync Rules. During each sync, the Adesso Server may remove unwanted contents, sends new contents and modifies updated contents on the user's client application.

Currently there are many ways of distributing digital on-demand contents over the Internet, but these solutions work based on always-connected (streaming) model.

Content.Now technology according to one embodiment of the invention takes advantages of an occasionally-connected feature provided by the Adesso platform and allows the digital content to be available even when user is not connected to the server.

Auditing

According to one aspect of the present invention, a capability is provided for creating a non-repudiable audit trail using public-key infrastructure. Such a capability may be provided, for example, among a group of occasionally-connected systems for tracking data changes in a distributed system. In one embodiment, technology referred to herein as Audit.NOW technology may be incorporated in the Adesso platform (e.g., Adesso Enterprise Server 3.0 and the corresponding Adesso 3.0 clients). Such a capability may allow creation of non-repudiable audit trails for data stored in the Adesso platform.

Given increased regulations and requirement for data handling (e.g., Sarbanes-Oxley, HIPPA, Basel II, Patriot Act, California Privacy Act, etc.) there is an increased burden on enterprises that manage sensitive data to ensure that they can report on exactly when, who, how, etc. that data was created, accessed, modified or deleted. For example, in the case of data that is used to construct financial statements and 10-K filings, it is now a criminal offense to sign-off on that data.

According to one aspect of the present invention, Adesso's Audit.NOW features and services permit the construction, after the fact, of secure, non-repudiable audit trails for selected data. More particularly, audit trails may be constructed, for example, for only those fields, records and tables that are subject to stringent regulatory requirements and/or would expose a firm to costly litigation.

In one embodiment, this capability may be performed with no-code changes to either the client or the server. Users who may have access to the data have no ability to intercept or modify the audit trail. At the same time, the user is protected from attacks that could occur at the center (the majority of intentional data corruption attacks occur within the enterprise or data center) that could create the impression that the user had performed the attack. This may be referred to as a DBA (database administrator) attack.

According to one embodiment of the present invention, the Audit.NOW technology performs the following functions:
tracking and recording actions performed on the edges (client devices) including modify, delete or insert of any data record.
Signing the audit information to detect any future audit manipulation (non-repudiablility).
Syncing the client audit information back to the server in order to store this information centrally (e.g., for reporting and tracking purposes).
Ability to select audit tracking for specific table or fields as well as specific activities (such as delete, update, add).

According to one embodiment of the invention, the ability is provided to audit existing Adesso applications (including applications that have utilized SyncLink, SharePoint.NOW and Files.NOW functionality) without making any code changes to the Adesso applications and without requiring that the user/administrator take any additional applications.

According to one embodiment, the Audit.NOW is an add-on feature that can be added to existing Adesso applications with no change in the application itself. Setting audit tracking capability to an application may be performed on the server after uploading the original application. After that when each user syncs with that application, Adesso client automatically starts logging users'activities.

When Audit.NOW is enabled on a specific table within the Adesso application, a client creates an audit log table and logs every user activity in that table. The audit records are signed before being stored in the audit table. During sync, the client sends all the newly logged records to the server and Adesso server stores them in similar table on the server database.

The audit information maintained at the edge device include the activity (e.g., updating a filed, deleting or adding a record, changing application design or schema), date and time, affected field and table.

Unlike traditional audit trails (e.g., log files and database journals), Adesso's secure Audit trail capabilities may utilize public-key infrastructure (PKI) to digitally sign the specific field change(s) on behalf of the user. According to one embodiment of the present invention, this signing is performed solely at the edge and the private key is only ever stored and accessible at the edge device (there is no central certificate authority in this model). Because the Adesso server has no copy of the private key, it is impossible for the server to “spoof” a change. Furthermore, since the audit trail is created at the edge—if at the center, a database administrator (DBA) directly modifies the database (potentially creating a record change that indicated an edge-user did something that they did not in fact do), the system is capable of automatically detecting that this in fact did occur. Coupled with the notification and alerting systems that will be part of Adesso's Management Server 3.0, an alert may be sent dynamically when this unexpected change is made by the DBA.

The “traditional” way of providing this level of audit and control includes designing directly into the database schema(s), the audit information and to hard-code, into custom client and server user facing code, the ability to create the appropriate audit fields and/or records. If the database(s) underlying schemas where to change, all the UI code would in all likelihood need to be rebuilt. According to one embodiment, the Adesso approach avoids this additional coding effort due to the design and implementation of the Adesso platform.

Another “traditional” approach includes custom middleware and/or web services to front-end existing enterprise data (SFA, CRM, ERP, SCM, etc.) as these schemas cannot easily (if at all) be changed. Here, the Audit.NOW technology in combination with Adesso's SyncLink technology as described above allows the occasionally-connected user to unlock and mobilize enterprise data—but you can do so with secure, strong audit trails. This capability is critical because these existing enterprise systems form the backbone of the modern enterprise.

Example Features

According to one embodiment of the present invention, a distributed application system may include one or more of the following features. Such features may be provided in the context of the Adesso platform, or may be implemented in another system or platform. Also, it should be appreciated that any of the following features may be practiced alone or in combination with any other feature.

1.1 Overview

According to one example, a system is provided that allows data to be updated in multiple location in a bidirectional manner. Further, the system permits files to be replicated and synchronized. Files and other database elements are monitored and updated whenever changed automatically. Also, the system includes a network transport-sensitive configuration to support file folder synchronization and as a result file folder-based business process automation.

1.1.1 Associate One or More Entities to Record(s)

Bi-directionally associate one or more entities to one or more records within one or more database(s) (e.g., relational or other type of databases), whereby an entity can optionally represent:

1.1.1.1 A File or Partial File

A file or partial file, i.e. a stream (sequence) of bits typically stored as a virtual, logical or physical unit within a container

1.1.1.2 A Storage Mechanism

A system designed for the storage of files (file system) which most commonly is a disk drive, connected directly or indirectly to a computer device. However, it can include any magnetic or optical storage devices, including but not limited to CD, DVD, SDIO Storage, RAM storage, and/or FLASH storage, etc. Additionally, in one embodiment of the current invention, the storage mechanism could include a special purpose storage system, for example, whereby programs (as opposed to an operating system function) dynamically arrange files or entities for consumption by another program.

An example of a specialized purpose file system could be a specialized device, possibly an RFID or other sensor-based device, whereby upon detection or reaction to a particular event the system updates a special information cache. In one embodiment, the system maintains an association between the device, through the specialized storage mechanism, and a record (e.g., within the Adesso platform).

An appropriate storage device according to one embodiment of the invention can be any device with some form of memory. In the above example, the specialized devices could be distributed across a multitude of manufacturing plants, other industrial facilities, utility companies, government facilities, private inventory tracking device, etc. Each device used in the field is a storage mechanism for relevant state information. The data collected through each device functions to create, delete, and/or modify entities that through the Adesso system are associated with other business processes.

Unlike other attributes of the Adesso system, one embodiment of the invention is dependent on the device and/or process being monitored—and functions independent of any particular user. For example, the RFID reader in a warehouse can be used to track inventory coming and going for a business; a flow rate sensor on a water pipe could track which fire hydrants were employed during the course of a year to help track fire activity.

1.1.1.3 An Organizational Structure

In one embodiment, one or more organizational units are provided to organize entities, e.g. files, folders, etc., into hierarchical or other types of structures, including directories, sub-directories, file folders, file cabinets, etc. In one embodiment of the invention, a particular type of organizational piece is encompassed in the notion of a “hot folder.” A hot folder is essentially a folder that encompasses an application and is reflective of the business processes or the unique consumer needs of the user.
Privileges distinct between records and folders
Unique properties as it relates to an application and a user's role within the application
Folder associated with workflow, based on business logic, has read/write permissions assigned to it to extend and reflect business processes
Addition to or modification of files in the folder dictates events within the application
   1.1.2 Mechanism for Associating an Entity to a Database Record

The challenge is to create an accurate and reliable mechanism for associating one or more record instance(s) (e.g., within one or more database(s)) to one or more entity(ies). There are several methods by which the association may be performed. The method can be based upon the type of entity and the assumed or actual conditions of the entity, the storage device, the database(s) and its state, as well as any optionally related component(s), i.e. type of computing device, availability of a network connection, current or potential user(s), as well as other external events or conditions. Additionally, the scope of the solution should include support for creating, modifying, and deleting record instances associated to an entity within a distributed environment and vice versa, i.e. entity to a record. The solution may encompass one or more database instances distributed amongst one or more devices. In one embodiment of the current invention, the following mechanisms may be employed:

1.1.2.1 GUID Record Identifier

According to one embodiment, a system is provided that employs the use of a globally unique identifier (GUID), typically in the form of a numeric or alphanumeric string, as the basis for uniquely identifying each individual record instance within a specific table, across all instances of a specific database. In a traditional relational database system, there are no inherent mechanisms to identify a specific record, except by its contents. Given this limitation, a system may be provided that stores the GUID as content within a record (e.g., as a field within a record), thereby allowing each record to be consistently and uniquely identified.

According to one embodiment, a platform is provided that uses GUIDs to isolate, abstract and manage the database implementation from business logic, from the presentation of the applications to the end user. Database elements including fields, tables, records, etc. use GUIDs, as do Adesso application elements such as controls, synchronization rules, etc. Due to the use of GUIDs, the various layers of the application (database, business logic, etc.) can be changed independently. Additionally, a late-binding approach to forms, views, etc. may be provided such that only upon actually opening of an application table, view or record will the system assemble the needed components. Because these are loosely-coupled from one another, they can easily be individually added/changed/deleted without having to simultaneously update all of the components. For example, a database field can be renamed without having to update the form that displays it because the Adesso platform manages the relationship between presentation and the database.

1.1.2.2 Support for Multitude of Distributed Devices

The system operates in a distributed environment and therefore the invention supports the ability to have a multitude of distributed devices, users, and/or programs creating, updating or deleting records concurrently on multiple instances of a particular database. Because each record has a static GUID stored within it, no two records are identical. In this manner, two or more separate instances from separate (or same) devices using two different instances of the same database can be immixed during the synchronization process without concern for uniqueness amongst the collective set of records. The creation, modification and deletion process may be managed, for example, by each device. Upon synchronization or immixing of data, the system may employ the use of the GUID to exchange the changes to the record(s) between two or more systems with two or more database instances.

This aspect of the invention is unique because there are no inherent mechanisms within a relational database system to identify a record—other than by its contents which may not be unique. According to one embodiment, an abstracted GUID layer can be used to uniquely identify the records, as well as any changes to them, for the purpose of potentially synchronizing two or more database instances. With standard database technology, where each record is only identified by its contents, if the content of two instances of one record were modified and then synced, the system would not be able to identify or update the records to reflect the appropriate changes. However, by assigning a GUFD to each record that can not be modified, it is possible for any number of complete content changes to occur over multiple instantiations of a record in an application, and upon sync for the system to properly update the record. Optionally, a system is provided that tracks all changes, no changes or changes between two entities which defies conventional relational database models.

1.1.2.3 Maintain Unique Identity Independent of Record Content

Additionally, because of the GUID-based record identification, it is possible to change some or all the content within a record. In this manner, regardless of changes to a record, the system has the means to evaluate changes from multiple instantiations across one or more devices to determine what changes were made to each record instance (see conflict resolution for more details on detecting and dealing with simultaneous record changes). The system can determine the delta between record instances and manually or programmatically determine what, if any, actions are necessary to merge data from each instance.

1.1.2.4 Content of Each Instance of Record or Database can Vary

The Adesso system supports any particular instance of the database or databases (e.g., on any particular device or devices) which contains a super-set, sub-set, or same-set of records at any given point in time. The GUID allows the merging of database instances through synchronization via manual or programmatic formulas. These formulas can be based on content within the record instance and/or data within different record or records and/or different system(s). Additionally, a record instance on any device or devices may contain a super-set, sub-set, or same-set of fields within that record at any given point in time.

For example, the content for a user on their office computer may contain a super-set of Adesso records—allowing all information to which the user has permissions to access to be available on that format. However, the same user may only have a sub-set of records on their personal PC—limiting the information that is stored and displayed on a device with finite memory and processing capabilities. In addition, the synchronization of the different instantiations of the same database can be customized per user, per device, per location, etc.

Application content among different users can likewise be very different depending on the user's location, job responsibilities, and/or device, etc. For example, a manager might be able to access information for all of the employees working under her, while each individual employee might only have access to the sub-set of information describing their own applications.

1.1.3 Accurately Associate Entity to Record (e.g., Within a Relational Database)

In one embodiment, the invention employs a method for accurately associating one or more entities to an instance of a record within a database, whereby:
The storage mechanism and/or container entity alone lacks relational, and/or transactional capabilities, the entities are not ‘normalized,’ lacks a schema, the data is not formally described, and/or lacks the ability to be accessed in a manner that does not require the data to be reorganized.
The term “accurately” can be interpreted as more true at or within a specified period of time, whether that is instantaneously, over long periods, or any intermediate time in between. This means that as a particular point in time approaches certain conditions will exist such that the association between entity and record is believed to be true. For instance, if the system has been configured to periodically poll an entity to check on its current state, then it is assumed that at a point in time close to the actual entity polling will more accurately reflect the actual record ←→ entity association than at a point in time further away.
   1.1.3.1 Programmatically Assemble Entity Identity Information

Because in standard relational database technology there is no normalized relationship between entities and records within a database, the current invention programmatically assembles and computes key information in order to identify an entity, to associate to a specific instance of a record, and to perform a set of functions on that entity and related record. Supported functions include the ability to find, report, delete, change, and/or retrieve specific data from the entity and the associated record instance without ambiguity. The Adesso system can be customized to support a wide range of data sources and can be configured to use none, one or more (e.g., either individually, a selective sub-set or all collectively) of the following data and/or information sources to both identify an entity and associate it to an instance of a record within a database:

1.1.3.1.1 File System Metadata

Nearly all file systems keep metadata about files out-of-band, whether it is in the directory entry or other specialized structures. A wide range of metadata is available and can range from simple timestamps, size, user or creator names to icons, free text and arbitrary attribute-value pairs.

1.1.3.1.2 Entity Parameters

Metadata may be used such as, for example, the entity name (e.g., a file name in a Windows-based file system, with or without syntax for filename extensions). Other information that may be used includes the entity size, location (e.g., file path), entity date when created, modified, etc., and other information.

1.1.3.1.3 Entity Type

Whereby entities, e.g. files, are seen by programs as streams of data and each program may support a particular format that describes how the data is encoded including the following methods of identifying entity type:

1.1.3.1.3.1 File Extension

A section of the file name may be used, and the section typically follows the last ‘.’ within the file name and is often referred to as the file extension. Examples include: .htm, .doc, .xls, .txt, .xml, .csv, .flg, .jpg, .wmv, etc. The extension may still inspect the filename extension even if the actual data within the file differs from the format specified by the extension, i.e. a user accidentally (or purposefully) renames a file with the incorrect file extension. In this instance, the ability may be provided to include one or more file format identification techniques in order to provide as robust or delicate format identification as is necessary, including no format identification for one or more file types.

1.1.3.1.3.2 Bit Analysis

According to one embodiment of the present invention, a capability may be provided to inspect data for the presence of a special constant or arrangement of bits to identify file purpose and/or format. While meaningful to implement aspects of the present invention, such constants would most likely be nonsensical to any other but targeted program. These bits (or bit tags) could be represented in any number of representations, including ASCII, hexadecimal, etc.

1.1.3.1.3.3 Entity Hash

In one embodiment of the invention, a system is provided that can leverage hash functions to uniquely identify a particular file, i.e. use the file binary as input to a hash function that will produce a digest that can be used to accurately identify the file. In addition, it is possible to incorporate more secure cryptographic hash function, such as MD5 or SHA-1, to both identify but also offer assurances of the integrity of the entity.

1.1.3.1.3.4 Entity Metadata

The ability to search for metadata within the actual entity, either directly from the entity such as a file (e.g., via a File Metadata Extractor) such as ID3 metadata from an MP3 file, or by leveraging a metadata cataloging feature in the operating system or some other program, such as Tiger (Max OS X) or Windows Vista (Windows WinFS).

1.1.3.1.4 Entity Attributes

Any related entity identity information can optionally be stored within an instance of the record within instance of database. Additionally this data, or any portion thereof, may be selectively distributed in conjunction with the instance of the record during the synchronization process. This information may be leveraged for creating and/or verifying the entity ←→ record association, pre and post distribution. It can also optionally be input into the manual or programmatic business logic used to ‘distribute’ or ‘route’ the record and any item within or associated to the record, including the entity itself, whether or not the entity is stored within the record. For instance, one scenario could have the routing logic leveraging the last modified date to only route entities that have changed within the last twenty four hours. The same could be said for file size, type of file, etc.

In this embodiment of the invention, metadata can be extracted from Adesso applications and relayed to devices in the field that cannot run Adesso, or other file formats in which critical information is stored. However, entity attributes can be taken from an Adesso application and distributed onto devices with limited memory and without distributing the entity itself. In addition, this distribution of entity attributes can occur without the loss of continuity between the original entity and the device on which it is associated. For example, according to one embodiment, the ability is provided to pass along data stored within an Excel worksheet integrated with Adesso displaying key totals (e.g. sales YTD) to a manager in the field on a mobile device such as a smart phone. Although the smart phone can not run the original Excel program or Adesso, the manager can view and act upon the crucial sub-set of information, while out of the office, by having access to the critical set of data.

One feature of this system uses the ability to selectively extract, distribute, validate and/or compare data within applications to almost any device with basic storage and display capabilities. The distribution of super-, same-, or sub-sets of information housed within an Adesso application can depend on the user, location, device, sync rule settings, and/or job function, among other variables.

1.1.3.2 User or Program Role

In one embodiment of the invention, the actual process of associating or verifying an association between an entity and a record can be dynamically selected based on the configuration of the system. The process can be dependent on information and/or data from the particular application, system, additional data from one or more systems, the profile of the user, and/or the program executing the function, etc. For example, an author submitting an entity may have less rigorous verification requirements than a user authorizing or approving a particular business process or transaction.

1.1.3.3 Optional Configuration Supporting Additional Parameters

In one embodiment of the present invention, it is possible to configure the system such that the techniques employed to create and/or validate associations are dynamically applied based on a wide range of optional parameters or data inputs. The list of parameters could include device type, time, date, user, application, entity type, size, location, urgency of synchronization session or data being exchanged, network connection, and/or security capability of device, etc.

1.2. Method for Monitoring and Anaging Changes Between Entity and Record

1.2.1 Method for Determining Whether Content has Changed

According to one embodiment, a method is provided for optionally monitoring changes to one or more entities based on its last known state of a record, if available, including new, modified, or deleted entities, and optionally including the metadata or related key information of an entity. Additionally, an option may be provided for monitoring an entity with the same or a constant state, i.e. an entity that has an unchanged or constant state. This feature offers potentially valuable insight into the state of an entity and can be incorporated into other systems and business processes through the use of the invention. Knowing the state of an entity is essential to knowing and/or managing the state of a related business process associated to the entity, related function or program and/or associated record and its associated data or systems. The system can incorporate this information into the entity ←→ record association so the association is true to the degree required by the system's configuration.

According to another embodiment, the ability is provided for a user, device or program to subscribe to any particular entity, including storage and organizational entities, so that each entity ←→ record association can be properly updated upon changes to either of the elements. The subscription process can be configured at a device, user, application, application class, client or system-wide level. For instance, for associating a file folder and its related contents to an application, the system can be configured to automatically monitor all files within that folder. In this example there is no need to subscribe to a particular file since the file folder subscription has been configured to create virtual subscriptions for all files within that container. According to another embodiment, the ability is provided to customize the subscription on a per entity or group of entities or class of entity, e.g. file folder, such that it may be less important to monitor in real-time excel spreadsheet files but very important to real-time monitor system management files. By associating a subscription to a class of entity it is possible to have the system ‘do the right thing’ and use the appropriate monitoring method used for that particular entity.

1.2.1.1 Automated Process Detecting Entity Changes

The Adesso system allows users to programmatically determine whether specific changes, or all changes (or no changes) have occurred to an entity or record by following a set of business rules, i.e. a pre-defined set of events and/or conditions to determine what entities, entity values, entity attributes, or specific information sources or values to watch for and optionally take action on (such as initiate an update of the entity ←→ record association). The configuration of the business rules and related monitoring function can be static or dynamic—for instance, the system might only monitor a select set of entities based on the specific sub-set of records and/or entities exist locally on any given device.

1.2.1.1.1 Real-Time (During Event Change)

In one embodiment, the system supports the ability to automatically update an entity ←→ record association for one or more entities by programmatically triggering a status change directly via entity function and/or execution. Specifically upon entity state change, if an entity were an executing program or file, it would be possible to have the entity programmatically modify the key information used in the entity ←→ record association and/or update the record, including related key information, and thereby eliminating the need for a separate monitoring method to accomplish the same.

1.2.1.1.2 Semi Real-Time (i.e., After Event State Change)

In another embodiment, the system can automatically update an entity ←→ record association for one or more entities by programmatically triggering a status change via a program or function. This program or function can be set up to receive or monitor specific triggers, events or other data/input sources that reflect an entity's state. For instance, if an entity is a file residing within a file folder, then an anti-virus program could detect a change to a file, and use this information to directly or indirectly update the entity ←→ record association and/or record.

1.2.1.1.3 Periodically (After Event Change Polled)

In yet another embodiment, the system can be configured to poll one or more entities and/or entity attributes evaluating it for changes and, as appropriate, update the entity ←→ record association, record and/or other related sources. This polling program or function can be configured to monitor specific changes, events and/or other criteria that may reflect an entity's state or change in state. In one implementation, the Adesso system can act as the polling agent and can execute both the detection as well as notification of entity change, when appropriate. An example of this is a recalc engine with the Adesso platform.

1.2.1.2 Semi-Automated Process Detecting Entity Changes (User Initiated)

According to another embodiment, an optional user initiated monitoring capability is provided to track specific changes, all changes, or no changes to an entity or record. Depending on selected user action, the system uses a set of business rules, i.e. a pre-defined or user assembled set of events and/or conditions, to determine what entities, information sources, and/or values to watch for and to optionally take action on (such as initiate an update of the entity ←→ record association).

For example, in some instances the user will know that he or she has updated a particular entity (e.g. file). The user could wait for the system to poll the folder system looking for changes. However, in this aspect of the invention it is also possible to automatically update the current or specified application associated with the entity or record simply by pressing a special key.

1.2.1.3 Configurable Method for Modifying Entity ←→ Record Association

Based upon changes or lack thereof, to an entity, record, database and/or application (such as a permission or design change, etc.) the system can optionally support a configurable method for programmatically modifying the entity ←→ record association. Such a method would be triggered to act upon changes to said entity, record, related metadata and/or data external to record or entity. Such a method can include custom created methods as well as leverage one or more of the following:

1.2.1.3.1 Entity is Source of State Change

If an entity is the source of a state change that has been detected by the systems monitoring capability, then one or more of the following actions can take place with or without user interaction depending upon the permissions assigned to the user and enforced locally on that instantiation of the record on that instantiation of the database on that instantiation of the application:

Through Adesso's unique entity identification system, a state change is signaled when an entity is renamed, even if the contents of it remain static. In addition, simple movement of an entity from one location within a container to another position in the container, a sub-container, or movement out of a container is recognized by the system as a state change. Once a state change is detected, the system can act according to its predetermined business or user logic based on the user, location, change made, and/or the device used, etc.

1.2.1.3.1.1 Create a New Record

When the state change determines a new entity exists within the environment being monitored, the system will create a new record including a GUID corresponding to the entity and can optionally populate the record with entity and/or associated attributes of entity into one ore more fields. Automatic population of records can be through related or computed data from other records, via table lookups, etc. can be populated within same record via expression or program execution.

1.2.1.3.1.2 Replace Corresponding Record

When a state change determines that an entity has been replaced, two actions are actually being recognized—deletion of an old record and addition of a new one. Alternatively, this change could be done by moving an existing entity and saving it in place of another entity. To make this type of action, a user must have appropriate permissions on the system, and the particular device being employed. Records may be replaced with or without backup and/or versioning.

1.2.1.3.1.3 Modify a Record

By modifying an entity, one or more fields within the record may need to be modified to maintain the correct level of association between the entity and record. The field-level modifications necessary could include the entity itself, metadata about the entity, and/or additional information either inputted manually. Manual input can prompt the user for specific data relative to the entity state change, or automatic input can be done through the use of an internal expression calculation engine or other programmatic facility. Modifications can include system-level properties related to the record, database and/or application, such as flags to indicate the source of change. For example, Adesso tracks which file was modified by which user—this system-level information is important as the system can optionally process changes differently based on the source and/or condition of change. Related or computed data from other records, via table lookups, etc. can be populated within same or related record(s) via expression or other program execution. Similarly, records may be modified with or without backup and/or versioning

1.2.1.3.1.4 Delete Corresponding Record

Another state change that can trigger system action may occur when an entity is deleted. Similarly, records may be deleted with or without backup and/or versioning.

1.2.1.3.1.5 Do Nothing with a Corresponding Record

According to one embodiment of the invention, the Adesso system allows application managers to attach additional conditions or events that are required prior to users deleting a record in order to maintain a set level of data integrity of database and/or entity. For instance, the synchronization process may require the record to be available to a particular user in order to complete a record update or other system-level function. Upon completion of process, the record will be removed if all other permissions and conditions are met.

1.2.1.3.2 Record is Source of State Change

If a record is the source of a particular state change (detected by the system's monitoring capability) then one or more of the following actions can take place with or without user interaction and dependent upon permissions (see permissions) assigned to the user:

1.2.1.3.2.1 Create a New Entity

The system may determine upon synchronization that a local copy of a new entity optionally needs to be created to correspond to a new record in the main system. It is also possible to have a new record associated to an entity and to not create a local instantiation of the entity based on user, application and/or system configuration parameters. In some cases it is not necessary to have the entire entity itself stored locally because the entity attributes that are distributed with the record allow information to be shared and on which collaboration can occur based on the company's business logic.

For example, an application can have data stored for a project that has people working on it all over the country. An individual working only in the Northeast would only be hindered by having access to all of the information stored within the application because it would take up valuable memory on the device, and take increased time and bandwidth to sync the application each time. Therefore, this embodiment of the invention allows selective access to applications based on any factor found pertinent to the users (job responsibilities, location, device used to access the system, etc.). For example, a regional or national manager of the same project may require access to a larger set of information—so their instantiation of the same application would include a super-set of information compared to the first user. In this embodiment of the invention, further customization of the information gained on sync is also available—for example the national manager may only receive information/records that represent totals in the various regions without them having to sort through all of the detailed information on every transaction to get at what is pertinent. Through a combination of sync settings and permissions, such customization options are easily accessible for business and private users.

1.2.1.3.2.2 Replace Entity

Entities may be replaced in the system with (or without) backup and/or with (without) versioning.

1.2.1.3.2.3 Delete Entity

Entities may be deleted from the system with (or without) backup and/or with (without) versioning.

1.2.1.3.2.4 Modify a Corresponding Entity

In this embodiment of the current invention, when Adesso detects a user modifying one or more fields within the record, including system properties, it can propagate changes upon sync to corresponding entities using flags to indicate the source of change. For example, if the data within a file was modified, then the system can potentially process these changes differently based on source of state change. The field-level modifications could include data or metadata about the entity or could include additional information either manually (prompt the user for data since the record is being modified) or automatically (through the use of an internal expression calculation engine or other programmatic facility). Related or computed data, from other records, via table lookups, etc., can be populated within same record via expression or program execution. An entity may be modified with (or without) backup and/or with (or without) versioning.

1.2.1.3.2.5 Do Nothing with Corresponding Entity

In another aspect of this embodiment, the system can require specific conditions or events to be met prior to deleting an entity in order to maintain a certain level of data integrity of the entity and/or record. For instance, the synchronization process may require the user have special permissions to modify, and/or delete an entity in order to complete a record update or other system-level function. Upon completion of process, the entity will only be removed if all other permissions and conditions are met.

with optional user notification.

1.2.1.3.3 Attributes of the Entity can Cause State Change

Attributes of the entity, in addition to the entity, that are modifiable could include: entity name, entity size, entity location and/or path, entity date and/or time stamp, entity type, file extension, hash of the entity, digital signature of entity, entity metadata, etc. Any modification of an entity attribute also signals the Adesso system that a state change has occurred, and the system may act (by prompting sync, or automatically syncing) or not act according to its configuration, the user, and/or the device, etc.

1.2.2 Refreshing Application Content

Based upon change to an entity and/or a record, the system may support the ability to automatically update data associated with the record and/or entity, i.e. the application content. In this manner, the state of an entity (and/or record) can be incorporated into the automation of business processes by enabling the entity's state change to have a secondary effect on other application data and/or even other applications.

1.2.2.1 Executes Any Necessary Expressions to also Effect Secondary Adesso Data Records

In one aspect of the present invention, Adesso supports the use of an expression language within applications. The expression language is a simple language that provides a way to program fields without coding or displaying return values that do not exist as data in the field or even anywhere in the application. Through this aspect of the invention, one can efficiently create, compare, and/or modify strings, as well as parse text and data systematically using information from an entity, its attributes, and/or related information, i.e. entity's metadata. Upon creation, modification, deletion or other entity change, the system will follow the ‘logic’ of the application by executing any related calculations on the entity, record, database, and/or application. An application in this context, as well as any in any aspect of the invention, can include systems and data beyond identified data set through other application integration techniques and services, including web services, direct database access via views or ODBC or other data integration tools and services.

1.2.2.2 Notification of Changes in Application While User has it Open

Within traditional database systems, there is no inherent way of tracking whether multiple users or programs have particular records and/or entities (i.e. document files) open. However, according to one embodiment of the present invention, a method is provided for determining in real time, in fixed increments, or as dictated by the method chosen for monitoring, and/or upon user initiation, whether there are multiple instances of the same record and/or entity being used and modified. This feature is designed to allow users to know when the record and/or entity or related metadata that is currently in use or associated with the active view has been changed. Without this capability, if multiple instances of the same record or view of records are open and/or being modified, then the information in each instantiation may not be accurate. The Adesso system provides this feature to prevent users and/or programs from working on inaccurate information, making duplicative changes to the system, and/or losing information, and potential for creating data integrity issues, etc.

In yet another aspect of the invention, the system supports the ability to programmatically alert the user, system or program via a queuing mechanism such as a message, event, visual, audio, or other indication (i.e., a message, trigger, etc.) that a particular entity and/or record has changed and therefore the current working data set in use may be affected. In this situation, the purpose is to eliminate or at least minimize any data integrity or loss associated with a current working set having changed. The Adesso system supports the ability to provide several out-of-the-box options to eliminate or minimize data integrity or loss. In one embodiment, the system can automatically create backup copies of the working data set, thereby allowing the user to then manually review and merge the working set with the stored data set. In yet another embodiment the system can automatically merge the working set, prompting the user to allow the merge or providing a program to automatically deal with relative changes. Either option can detail information about the change(s) made such as source of change, date/time of change, system or author of change, etc. Using this information, the system can use configured logic to programmatically merge the changes or optionally guide the user through the process of merging the changes. Further, the system, if desired, can allow duplicate entries to exist each with a unique version. Upon the process of synchronization, these changes will be propagated to one or more instances of the particular database or application.

Furthermore, at least one embodiment of the invention supports the option to intelligently determine data set impact by examining the logic within the application and ascertain whether or not the change has an impact, or optionally a particular level of impact, e.g. minor, major, etc. In some cases, although an entity changed while a user was working on a particular data set (the change could have propagated from the hub (e.g., a server) or via some other program executing on the device), the actual attribute change within the entity may not be tied to any logic within the application. For example, if an excel spreadsheet had been modified by user A, changing a specific cell (from ‘submitted’ to ‘approved’), and another user, user B, was working on the same entity and/or related record, but modified another value related to the ‘total value’ cell, then user B's working data set would not be impacted by the underlying spreadsheet change. Additionally, the system supports the ability to do field or even partial field updates (in the case of a binary changing, only the bits to make the binary contents equivalent). In this manner an entity and/or record can change but with no impact to a user or system current working data set (i.e. the open record and/or entity).

1.2.2.3 Background Synchronization of an Open Application

In another aspect of the invention, the system supports the ability to synchronize an application, including related entities, records, databases, etc. as dictated by system configuration and related background synchronization rules. In this mode, the system can be configured to programmatically respond to synchronization process, including any conflict resolutions that might need to be addressed (see conflict resolution). Additionally the system can be configured to prompt the user via visual or other alerting mechanism, regardless of whether the user is current using the application or not.

The challenge is to eliminate, or minimize, any data integrity or loss associated with any entities, records, and/or associated data related to the synchronization session. The system supports the ability to provide several out-of-the-box options to eliminate or minimize data integrity or loss. In one embodiment, the system can automatically create backup copies of the working data set allowing the user to then manually review and merge the working set with the stored data set. In yet another embodiment, the system can automatically merge the working set upon prompting by the user, or by providing a program with relative changes, including information such as source of change, date/time of change, system or author of change, etc. Using this information, the system can use configured logic to programmatically merge the changes, or optionally guide the user through the process of merging the changes. Further, the system can allow duplicate entries to exist each with a unique version. Upon the process of synchronization these changes will be propagated to one or more instances of the particular database or application.

Furthermore, according to one embodiment, the system supports the option to intelligently determine data set impact by examining the logic within the application and ascertain whether or not the change has an impact (or, optionally, a particular level of impact, e.g. minor, major, etc.) on either the entity or record and then take no action (acknowledged change occurred but do nothing or optionally abort synchronization session) or take action programmatically using predefined rules and/or allowing manual intervention. Additionally, the system supports the ability to do field or even partial field updates in the case of a binary being modified, only the bits necessary to make the binary contents equivalent are exchanged and applied. In this manner an entity and/or record can change without impacting a user's or system's current working data set (i.e. the open record and/or entity).

1.2.2.3.1 Tailored Set of Rules for Data Change Notification for Each User Possible

Based on business logic of the company
Manager's changes might be set to always override changes made by lower level employees (notifies that changes have been made and update's user's copy)
Workers belonging to a certain department can have their changes override changes made by workers outside of the relevant dept.
Automatic saving of versions if no clear way to prioritize one set of data v. another

Rules can be formatted by job function, device, user group, etc.

1.2.2.3.2 Analogous to Permissions

Ability to use any variable (type of data change, user, device, time of day, etc.) to customize this option

Attached to a particular instantiation of an application—stored on server and sent out with the application upon sync

Dynamically variable—any change made will automatically go into effect upon sync of the setting

Part of schema (so synced first before data)

1.2.2.3.3 Static or Dynamic Business Rules can be Applied

The configuration of the business rules can be static or dynamic. For instance, a user could have recently saved a new file to a file folder—thus creating a state change. In response, the system may automatically, manually or prompt the user to synchronize the folder with the application. This feature reflects the business logic of the user—allowing customization of the Adesso system for any set of business rules, and can thus keep the record and entity association accurate and all related data consistent.

1.2.2.3.4 Can Be Done for User Merely Viewing Data

1.2.3 One Embodiment of the Present Invention Includes a System Service

In one embodiment, the system can be configured to use existing user interface mechanisms for any required data input and output operations. In one embodiment, the system can leverage an entity as the primary method for any required data creation, modification, and deletion. It is possible to use a word processor, a spreadsheet program, or other to document-based editing tool to create data that would ultimately be incorporated into an application or business process. Additionally it is possible to use existing storage containers as the organizing and viewing mechanism for both accessing and navigating information within the application but also using same for additional data that can be used within the system to implementing additional business and process automation logic. According to one embodiment, it is possible to use available client user interface tools, including productivity tools such as MS Office, etc. to provide the actual presentation and manipulation of data that will be leveraged by the system. Additionally, it is possible to represent an Adesso application within the file explorer tree structure such that elements of an Adesso application can be viewed within the context of an explorer tree, using existing nomenclature or creating new word, icon or other interface representation options. In one embodiment, it is possible to represent tables as folders and records as files and fields as file metadata. Each of these records might actually be representative of an actual entity within the folder itself whereby it would be possible offer multiple views of the application and/or entity information including new views of the ‘tree’ that can replace, augment or co-exist with the standard file explorer interface.

For example, it is possible for an entity, a storage container entity, and an organizational entity all have independent relationship associations within the system. These additional entities can be used to create additional information based on known relationship between one or more entities and these storage and organizational entities. For instance it is possible that the existence of one or more entities within a particular storage container could in fact create additional metadata or data about an entity—including what device, user, physical location, or other attributes, that would then allow the system to execute specific business logic based on current state of the entity and its relationship within a container and/or organizational entity. An example of this might include an expense report being saved within a particular file folder on a computer. Upon saving the file into the ‘submitted’ folder the system would create and/or update the record ←→ association with these additional container-related entities such that the system would now be able to dynamically execute a work flow algorithm using this information. For instance, when the signing authority of an expense report synchronizes with the service the system would execute synchronization logic to transmit any expense reports that have been placed within the ‘submitted’ folder—based on who submitted the report, who the signing authority is—using data from another system such as an HR system, and then upon that person or device synchronizing transfer the record with or with the expense report to approve the payment. The approver could accomplish this simply by moving the expense report from the submitted to the approved folder and have the system move the expense report to the accounts payable department.

One embodiment of the invention supports the ability to provide additional annotation capabilities outside the entity that will be used as additional metadata about the entity within the system. Upon the creation, modification or deletion of an entity the system can provide an interface that a user and/or program can use to populate, edit or delete and then can be associated with the record related to the entity. The annotation editor could be a form generated by the system or could be a separate custom or commodity program, such as Windows Notepad.

The system can operate in the background as an independent process or even as within the system process in order to interact within an environment with minimal or no deltas between the state of an entity and the record ←→ entity association as well as the update of the content within the record representing the entity within the system. In this manner it is possible to directly manipulate the presentation of the application information in real-time or semi real-time with the changes taken place with the entity and/or associated record and any related content or resources. In this manner, it is possible to signal a view change of a container based on the direct manipulation of a file within a particular folder. Simultaneously it is possible to embed a non windows file folder view within the windows explorer shell such that the Adesso application, because it is running as a system service, can manipulate and respond to system service calls and replace specific functionality, such as an enhanced view mechanism that can display related metadata from within an entity as part of the standard explorer display options.

1.2.3.1 Method for Configuring System to Optimize Performance

When modifying any data, whether it be related to the entity, record, database, and/or application, it is possible to use a variety of tools and techniques to optimize performance. The system's performance is streamlined by minimizing the amount of data stored, transferred and/or processed during sync in order to maximize storage, network connection speed, device processing power, etc. According to one embodiment of the invention, the system employs binary patch capabilities to selectively distribute (sync) only the portions data and necessary supporting data (e.g. type of algorithms being used, etc.) that have been changed. This methodology is applied to eliminate the differences between the two or more instances of an application while minimizing the time and connection requirements for the data transfer. In one embodiment, the system supports the ability to customize the overall performance of the system, based on one or more factors, with respect to level of data integrity and ability to repudiate the association between the entity and the record. This includes, but is not limited to:

1.2.3.1.1 Business Need

According to one embodiment of the present invention, Adesso applications can be configured to facilitate exchange of information between a small trusted group of users with similar goals and interests. This embodiment of the invention focuses more on Adesso's sharing and collaborating functions than enforcing or monitoring the accuracy of an entity and the records with which they are associated.

In many private or business environments, such as collaboration between trusted partners, high levels of security are not required and may be counter to the productivity of the partnership. Adesso provides the ability to set up very simple content routing rules and permissions, including ASP-based deployment. Alternatively, Adesso also has the capability to provide higher security through proper configuration of the system. In addition, security can be layered on using Plug-In programs to augment the system's inherent capability. Essentially, the Adesso system allows users to select and control the appropriate level of security based on the application, users, location, business or personal need for security, etc. This is yet another unique way that Adesso provides users with the ability to customize their system setup and requirements based on individual and/or business needs.

1.2.3.1.2 Device Usage

The Adesso system, in another embodiment, has the ability to assign distinct sync rules for a single user depending on the device being utilized to access the system. For example, if the device used is a smart phone it may not be possible or worthwhile time-wise, to go through the process of hash comparison of a large file. However, on a laptop computer the processing capacity is robust enough that this level of validation can occur with no real performance side-effects. In addition, sync rules can also be set regarding file size for particular devices.

1.2.3.1.3 Data on Demand

In one embodiment of the invention, users can select local parameters for synchronization based on the size of the file, folder and/or container to be synced, and selectively skip the sync of large files. Data on Demand is a feature that provides the user (for example, one with low connectivity, or using a low memory device) the ability to selectively prevent or postpone sync of large files. Initially, the sync engine downloads a snapshot of each file, folder, and/or container, specifically including the file attributes, and populates a binary transfer cache table detailing each file, folder and/or container and its properties available for sync during that session. All files, folders, and/or containers that are under the set limit for sync are automatically synced. Once sync ends, the files, folder, and/or containers larger than the sync limit are displayed for the user in the binary transfer cache table, and the user may choose to selectively sync the larger files, or to end the sync session without downloading the large files. The sync size limit can be dynamically altered, initiating the sync of files below the new size limit, and above the old size limit.

1.2.3.1.4 Forced Synchronization

In another embodiment of the invention, sync of particular files can be forced, no matter what the size or sync limits that the user has set. Forced sync can bet set by a user for any file, folder and/or container that they want to sync, regardless of its size. By providing users the ability to control the content of information a user receives on sync, the utility of remote, occasionally connected devices is maximized—time is not wasted downloading large files that the user does not feel is necessary for their immediate work needs. In addition, allowing forced sync ensures that important information important to the business function of the individual user is not missed.

1.3 Method for Extracting Metadata about/from Entity

Once an entity has been associated to a record, another aspect of the invention supports the ability to extract information, i.e. metadata, from an entity, such as a file, using a metadata extractor. Upon extraction, the system can optionally populate the metadata into the record using a well understood name/value pair format, such as XML, without the user having to have any knowledge of XML or concepts of metadata. Further, the embodiment leverages the entity ←→ record association allowing what is otherwise ‘unstructured’ information to be converted into a structured format, by extracting the information into a well defined name/value pair typically in an XMIL format. This metadata can then be used within the database and broader application. The system can execute prescribed business logic, locally or remotely, on the metadata that can be optionally stored within the record. In this manner it is possible to leverage the metadata along with the other data in the record and database to perform specific business process automation logic, including workflow and data routing. Additionally, all data, including the extracted metadata can be leveraged within the synchronization rules for distributing the entity and/or related records and application data. Optionally, actions by a user or the system could result in the metadata being modified and through the entity ←→ record association the entity could then be updated to reflect changed state of metadata, keeping the record and entity identical.

In one embodiment, the system employs the use of a file metadata extractor which extracts relevant information from well-formed entities, typically files. The information includes metadata of the entity, as described in the file or document, such as title, author, source, etc. Additionally, the system may extract very specific information related to the actual content of the entity. For example, in a spreadsheet file this information could include the value of a named range, and in a project management file it could include a task name within a project. Other metadata may be extracted and used by an application. It is possible to have the metadata extractor work with pre-existing entities, e.g. already existing spreadsheets or word processing documents. Using a very simple, no code approach, the system can automatically identify and pull out well-known information about a particular file or file format. The system can support predefined, i.e. out-of-the-box, or custom extractors whereby custom extractors are typically designed for proprietary entities and predefined extractors can support commodity entity types, including files with formats compatible with popular office productivity and media programs such as Word, Excel, Project, etc.

In yet another embodiment, by simply placing a file in a particular storage mechanism or storage organizer, such as a file folder or sub-directory, the system will automatically associate or update an association between an entity and record. Optionally, the system may then extract (or re-extract) relevant metadata from the entity. The system can be configured to extract specific metadata based on a particular file type, format or other entity identifier and/or by the specific container an entity resides in. These containers, optionally designated as ‘hot folders,’ can be designated to specific business functions or actions based on the configuration or business rules of the system. Further, by using simple drag-n-drop operations on an entity, i.e. dragging a file from one folder to another, the user may take part in a well structured business process.

An example of folder based business process automation using the drag-n-drop feature of Adesso can be shown through expense report transactions within a company. Using this embodiment of the present invention, an employee can access the most up-to-date expense report form within the Adesso system. Permissions can allow the employee to fill out certain fields of the form (for example listing of expenses incurred) while blocking other fields (such as manager approval). Once completed, the employee can drag-n-drop the form icon to a specific folder or sub-folder to submit it his manager's approval. The action of movement of the expense report form into the folder for approval changes the file's permissions to allow the submitter to have read-only capabilities and no ability to modify the document once submitted. Behind the scenes Adesso business logic can then route the expense report to the proper manager's attention for approval based upon such things and submitter, office location, and/or amount of total expenses, etc. Once approved, or denied by the supervisor, another simple drag-n-drop gesture into another folder can automatically route the expense report to accounts payable where the appropriate check can be written. The original worker submitting the report has the ability to follow the process, but has no ability to alter the document in any way.

According to one embodiment, it is possible to leverage the transaction-based nature of the record and related database to track changes to an entity, both content-wise as well as movement or placement of the entity within a specific container, such as a file folder. By virtue of the entity ←→ record association, any changes made to the entity have corresponding updates to the record and therefore can be tracked systematically. In this particular invention it is possible to create an audit trail of the transaction states of the database locally and/or while synchronizing with one or more servers. A trigger mechanism is implemented within the database whereby upon a change to a specific record and/or field within a record the system creates an audit entry in another table. The entries can be digitally signed and/or encrypted in order to prevent unauthorized manipulation. Upon synchronization, the system transfers the audit table entries from the client to the server where they can be validated as well as viewed and reported on. Extrapolating further, each time the metadata extractor executes against a particular entity, some or all of the metadata is optionally populated into the associated record. These changes trigger audit records to be created thereby allowing a distributed file auditing facility.

In one embodiment, entities, such as files and file folders, can be associated with records within an Adesso application. The current example of the auditing functions of the program thus allow tracking of not only direct modifications to the records, fields, forms, etc. of the Adesso application, but also allows tracking of all information contained in the entities associated with all applications. Thus, the auditing capabilities inherent to Adesso also can track and record changes to entities such as Excel spreadsheets, Word documents, and any other unstructured information associated to an Adesso application. This capability is crucial in today's business environment that demands strict accounting for modifications of business information, especially financial information. Through the example above, Adesso provides a method for companies to comply with such government requirements as the Sarbanes-Oxley Act, etc.

Audit trails generated through the example above can not be easily accessed or modified since they are stored outside of the application. According to one embodiment, audit trails are stored on the server, making modification by users through the client impossible. In addition, once the auditing functionality is turned on, even a user on the server side is unable to make changes to the audit trail without their activities also being recorded. Thus, a method is provided for preventing the data and audit manipulation problems that lead to the collapse of financial giants such as Enron Corp.

Audit trails are crucial features for some applications, however one embodiment of the present invention allows a user/business to choose which applications are appropriate for tracking. Thus, an Adesso user has the power to determine when it is appropriate to have an application's modifications tracked, and when it is not justified. For example, tracking of financial transactions may be crucial for compliance with Sarbanes-Oxley, but tracking of Board of Director's materials may not be important. Adesso allows users to only track applications that are required—thereby freeing up server space, processing time, and other important resources when auditing capabilities are not needed.

1.3.1 Metadata Extractor Interface

According to one embodiment, the system supports the ability to create custom metadata extractors in order to provide support for proprietary or protected formats (e.g., encrypted data requires additional information, credentials, and crypto functionality) and by defining two simple interfaces and returning an XML document with metadata results, the system easily allows customers, partners and integrators to develop metadata extractors for specific business needs and incorporate results into broader applications and solutions as described above. When the system is ready to extract metadata from an entity the metadata engine determines if there is a custom metadata extractor registered for that particular entity or related folder [container]. If so, the system calls the custom extractor and awaits the XML metadata result. Furthermore, it is possible to have a custom metadata extractor override the system default extractor on a per table, per database, per application, per device, or per user basis.

Customized extraction of specific types of metadata can be achieved through the use of specific Plug-In programs. According to one embodiment, the ability to customize the extraction of metadata is provided, thus fulfilling business goals by allowing the extraction of only pertinent information without wasting time or effort extracting information that is of no use to the particular customer. Extracted data can be written out to a file to add or update existing information within the Adesso application.

1.3.2 Metadata Extractor Execution

1.3.2.1 Client or Server-Side Execution

The metadata extraction process can execute locally or remotely on the server or other select client devices. It is possible to leverage the Adesso synchronization engine to aggregate entities to one or more systems that are designated for extracting metadata. Specific routing logic can be configured based on the availability or inavailability of metadata within the record. If none exists, then the entity and/or record can be routed to a particular server, client or device. In another example, the system supports the ability to do server-side metadata extraction, with the advantage being a predictable and uniform metadata extraction experience, since the system supports a multitude of client devices, each with varying capabilities relative to program execution for specific entities. As an example, it is unlikely a basic smart phone would be capable of running an excel spreadsheet; and, even if it did, it would most likely only support a sub-set of functionality compared to its desktop cousin. Additionally, by supporting a centralized metadata extraction facility, the system could support a wide variety of entity types by requiring only a few specific devices to have the appropriate programs and/or related metadata extractors.

1.3.2.2 User Initiated or System Initiated

According to another embodiment, the system supports the ability for users and/or the system to initiate the extraction (initial or update) of metadata from an entity. If the system was configured to monitor an entity via a polling or similar method, it is possible that the timing of the next configured polling might not be conducive to a user's needs at that particular time. In this situation, the system supports a manual option for users to initiate an initial or updated metadata extraction. Additionally, based on certain conditions within the system, it might be necessary to have the system automatically execute the metadata extraction function in order to maintain integrity of the data with the record, database and/or broader application. In one embodiment, the system supports the calling of one or more metadata extractors via a special expression within the system. If the system determines that one of the key information sources used to maintain the entity ←→ record association has changed, then the system can use an expression to determine conditions, as well as to call the metadata extractor directly via the GetMetaData function call. This call is readily available and can be incorporated into any expression statement thereby giving flexible control over how and when metadata extractors are executed.

1.3.2.3 Associating Metadata Extractors to an Entity or Type of Entity

The Adesso system can be customized to support a wide range of entities and can be configured to use none, one or more either individually, a selective sub-set or all collectively, of the following data and/or information sources to associate an entity or entity type to a metadata extractor in a manner similar to the above with respect to associating an extractor with a record.

1.3.2.3.1 File System Metadata

Nearly all file systems keep metadata about files out-of-band, whether it is in the directory entry or other specialized structures. A wide range of metadata is available and can range from simple timestamps, size, user or creator names to icons, free text and arbitrary attribute-value pairs. The extractor could be associated to one or more these elements.

1.3.2.3.2 Entity Name

Using the entity name for example—a file name in a Windows® file system, with or without syntax for filename extensions.

1.3.2.3.3 Entity Location and/or File Path

1.3.2.3.4 Entity Type

Whereby entities, e.g. files, are seen by programs as streams of data and each program may support a particular format that describes how the data is encoded including the following methods of identifying entity type:

1.3.2.3.4.1 File Extension

Use a section of the file name, typically following the last ‘.’ within the file name and often referred to as the file extension. Examples include: .htm, .doc, .xls, .txt, .xml, .csv, .flg, .jpg, .wmv, etc. The Adesso system can use this approach even if the actual data within the file differs from the format specified by the extension, i.e. a user accidentally (or purposefully) renames a file with the incorrect file extension. In this instance, the system supports the ability to include one or more file format identification techniques in order to provide as robust or delicate format identification as is necessary, including none.

1.3.2.3.4.2 Bit Analysis

To facilitate the identification file types, the Adesso system may look for the presence of a special constant or arrangement of bits to identify file purpose and/or format. These bit tags can be used by Adesso, while such constants would most likely be nonsensical to any other but targeted program. These bits could be represented in any number of representations, including ASCII, hexadecimal, etc.

1.3.2.3.4.3 Entity Hash

In one embodiment of the invention, Adesso leverages hash functions to uniquely identify a particular file, i.e. use the file binary as input to a hash function that will produce a digest that can be used to accurately identify the file. In addition, it is possible to incorporate more secure cryptographic hash function, such as MD5 or SHA-1, to both identify but also offer assurances of the integrity of the entity.

1.3.2.3.4.4 Entity Metadata

The ability to search for metadata within the actual entity, either directly from the entity, e.g. file (see File Metadata Extractor) such as ID3 metadata from an MP3 file, or by leveraging a metadata cataloging feature in the operating system or some other program, such as Tiger (Max OS X) or Longhorn (Windows WinFS).

1.3.2.3.5 Entity Attributes

Any related entity identity information can optionally be stored within an instance of the record, within instance of database. Additionally this data, or a portion thereof, may be selectively distributed in conjunction with the instance of the record during the synchronization process. This information may be leveraged for creating and verifying the entity ←→ record association, pre and post distribution, and optionally as input into the manual or programmatic business logic used to ‘distribute’ or ‘route’ the record and any item within or associated to the record, including the entity itself, whether or not the entity is stored within the record—(see file metadata extraction). For instance, one scenario would have the routing logic leveraging the last modified date to only route entities that have changed within the last twenty four hours. The same could be said for file size, type of file, etc.

1.3.2.4 User or Program Role

In one embodiment of the Adesso system, the actual process of associating or verifying association between an entity and a record can be dynamically selected based on the configuration of the system. The process could be dependent on information or data from the particular application, system, additional data from one or more systems, the profile of the user, and/or the program executing the function, etc. For example, an author submitting an entity may have less rigorous verification requirements than a user authorizing or approving a particular business process or transaction.

1.3.2.5 Optional Configuration Supporting Additional Parameters

In this embodiment, it is possible to configure the system such that the techniques employed to create or validate associations are dynamically applied based on a wide range of optional parameters or data inputs. The list could include device type, time, date, user, application, entity type, size, location, urgency of synchronization session or data being exchanged, etc., network connection, and/or security capability of device, etc.

1.3.3 Optionally, Metadata May be Harvested Based on:

1.3.3.1 Application Parameters

According to one embodiment parameters can be changed at any time (dynamic alteration) & changes take effect upon synchronization.

Different instantiations of the application can have different parameters associated with them.

Parameters can be customized for users, user groups, devices, etc.

1.3.3.2 Availability of Metadata Extractors

If a file extension has no metadata extractor associated with it, then no extraction of metadata within the file can occur.

Some common file types may be made available through the Adesso platform.

Can add extractors to the Adesso platform through, for example, the use of Plug-In programs.

Those extractors can be customized to provide only certain types/fields of metadata during the extraction.

Can be made for any existing or new file type.

Because the platform may be expanded, the Adesso platform allows companies to keep up with the future (file types) of technology.

According to another embodiment, the ability is provided to support and extract data from any file type—regardless of its popularity or length of use.

Any custom setting within the Plug-In can be changed on demand by alteration of parameters or through association of the program with different resource programs.

1.3.3.3 Permissions

According to one embodiment, the system includes an ability to define, at a very granular level for each application, what information users can read, modify, delete, export, share, etc. Assigning permissions is an important part of the overall synchronization process. Permissions can be assigned to one or more logical entity, including users, user groups, devices, and/or programs. The combination of synchronization rules coupled with permissions creates the overall process for determining what data flows to what device and/or user, and when. Some of the more granular permissions include the ability to define whether a user or device has the right to read a table column, add records, delete records, modify records, modify own records, and/or change the application schema. In addition to enforcement at the application level, the synchronization process can optionally enforce permissions. If a synchronization rule was simple in nature, i.e. synchronize table X, then the synchronization process could enforce the appropriate permission by only sending down the data that the user and/or device had permissions for within table X. For instance, if a user has been given read permissions for all but field Y within table X, then all data except data related to field Y would be transferred upon synchronization. All application components can also optionally have permissions assigned to them. As such, if a user or device does not have permission to access a particular application or area of an application, then the system will automatically not distribute that application schema element even though there was no specific synchronization rule detailing this constraint.

Application permissions allow control over every aspect of an application down to the individual user

Can be based on individual user, group of users, job titles/responsibilities, location of office, device used to access application, etc.

Can limit access to an application

Read only

Read & modify

Read, modify & delete

Create, read, modify & delete

Can control access to an application

By field

By form

By table

Per file within a filesync table

By data filter (i.e. based on location)

By user

By user's job role

1.3.3.4 Processing Capacities

1.3.3.5 Device Type Executing On

Adesso applications can be customized for specific devices, as well as user profiles.

Execution of an application on a device with small memory can cause the application to display only essential information. Further, the platform may be adaptive to display the data in a format that the device can support.

Less information harvested on small storage devices—and harvesting perhaps on a smaller set of data.

Example of smart phone—no ability to run the underlying programs that Adesso uses to store information (such as an Excel spreadsheet), but the user can still have access to information within the application that is needed

Limits on sync settings for applications based on device type

Ads—maximizes the utility of the mobile devices by not overloading them with information—limiting storage use increases the ease & processing speed of the applications running on the machines.

1.3.3.6 View and Sort Data Based on Metadata

1.3.3.7 Creates the Ability to View, Sort, Modify, Update

According to one embodiment, the capability may be provided to change the metadata of a file within a database.

1.3.3.8 Indicate to User ‘out-of-sync’ View Status and to Update (e.g., Via Manual or Programmatic Mechanism)

1.4 Network Implications

1.4.1 Smart Use of Bandwidth

Permissions may be used to limit the amount of information to which an individual user has access to, and therefore has need to synchronize between a client and server.

Applications can be selectively partitioned into any number of pieces to customize the information presented within them.

1.4.2 Smart Use of Device Resources

Distributed, by definition, means that something is spread out or scattered. In a distributed application system, some of the key aspects for a reliable, scalable solution include the ability to eliminate remote dependencies for performance reasons—application performance can be dramatically improved if the device is using the local processing power for constructing a user interface versus having to deliver user interface elements over a network regardless of bandwidth. This is especially true in a mobile environment where no internet connection may be available. In that situation, the local device depending on the server to construct the user interface would not be able to fully or partially execute the application. For an application to operate in a self-sufficient manner, it needs to have available to it all resources—which in addition to the data, the user interface, and code, also includes roles, permissions, access control rights, etc. According to one embodiment, the system supports a specialized manner of distributing an application and its related resources, including Plug-Ins, such that any application instantiation regardless of device is self-contained and self-updatable through the Adesso synchronization process.

1.5 User Interface

1.5.1 Drag-N-Drop Gesture

The system supports the ability to use a drag and drop user interface metaphor as a means to implement specific process automation steps. Because an entity and optionally the container and/or organizational entity it is contained within have known, meaningful associations to the application, it is possible to implement very specific business function by simply dragging and dropping a particular file from one folder to another and by virtue of this action implement very specific business workflow functions. For example, if a user drags a spreadsheet containing specific information about a potential upcoming sales deal from one folder called ‘leads’ to another called ‘pipeline,’ the user has essentially entered a new account into the sales pipeline. This is part of the overall sales automation process. This information is then shared, with or without the actual file, to other participants in the sales process which could include sales management, executive management, pre-sales support, etc. Using the facilities of the system as described in this disclosure, information could be automatically extracted from the spreadsheet and then used to determine who should see this information. Upon synchronization of the various application users this new pipeline information would be included in the revenue projection process and might automatically trigger the assignment of an account manager or pre-sales engineer. Further, a folder-based rule association may be used.

1.5.2 Account Management Implications

According to one embodiment, the supports the ability to set permissions to specific entities via the entity ←→ record association that exists within the application. Because the Adesso system supports the ability to associate a set of access control rights as well as permissions, such as read, write, delete, modify, etc., to all the elements within the application itself on a device, user, program, client, etc., it is possible to associate, indirectly, permissions to entities. In this manner the system supports the ability to assign create record privileges to a particular table. Because the system can be configured to associate a particular table to a particular folder, the system will monitor any changes within the folder and upon an entity being created or being newly associated to the folder the system will create an associated record within the table. The record can optionally contain information about the entity including the entity itself. If a user, program or device did not have the appropriate permissions, then the system would not allow creation of the corresponding record and optionally might delete the entity from the file folder itself, thereby enforcing the permissions even if the enforcement was post actual creation. In this manner it is possible to enforce proactively or reactively depending on control of the application and related interdependent systems and programs.

1.5.3 Adesso Application Shown on File Explorer Tree

1.5.3.1.1 Windows Explorer Integration

According to one embodiment, a virtual association may be made through a database view of the Windows Explorer tree. In one example, attributes of a container may be stored within the application database. According to another embodiment, the system and can be assembled dynamically to replicate windows explorer views but can be sorted or manipulated to represent unique views. According to one embodiment, the system may store basic information associated with the file (e.g., data typically accessible through Windows Explorer). Further, file metadata information (e.g., standard JPG file information) may be inspected and stored in the database. Further, metadata that can be obtained by “cracking” the file may also be included.

Permissions information to files may also be interpreted and stored in the system, and may be used to control access to files. For instance, there may be read-only, modify, delete, and add permissions which may be based on an individual or a group of users. Such permission information may be stored in the server and sent out to the client at the start of a session. Further, access to data may be based on relationships (e.g., cost for a subscription service automatically linked to user's subscription) defined within the system. Also, access may be provided based on synchronization rules defined by an administrator. For instance, using synchronization rules, information may be controlled by pushing it out to designated individuals. Business logic may be used to control the flow of such information.

1.6 Subscription Services

1.7 In One Implementation, Users can Selectively Subscribe to Particular Information Stored Within a File Sync Table

1.7.1 IFF it is Accessible to the Specific User (Meaning the User has Permissions to Access the Adesso Application).

1.7.1.1 Granting Permission to Access File Based on Business Logic/Business Processes of Company

1.7.1.1.1 Type of Permission Granted (CRUD)

1.7.1.1.2 Permissions Assigned to Individual User or Group of Users

1.7.1.2 Specific Files that are Accessible to Users Based on Many Variables

1.7.1.2.1 Function/Job Title

1.7.1.2.2 Office Location

1.7.1.2.3 Necessity of Access to Information

1.7.2 Can Make Some Files Within Folder(s) or Subfolder(s) Accessible to Some Users Without Granting Access to the Whole Thing

1.7.2.1 Can Provide a High Degree of Control/Personalization to Access

1.7.2.1.1 Easy to Control Access by Account Manager

1.7.2.1.2 Easy to Change Control of Access when Needed and Sync on the Fly

1.7.2.1.3 All Applications Run with Inherent User Rights and Content

1.7.2.1.3.1 All Applications are “Personalized” for the User

1.7.2.1.3.2 Permissions Stored on the Server and Are Sent over with Initialization of Adesso Program

1.7.2.2 Ways to Customize Access

1.7.2.2.1 Sync Rules

1.7.2.2.2 Permissions

1.7.2.2.3 Views

1.7.2.2.4 Filters

1.7.2.2.5 Forms

1.7.3 In one implementation of the system, this feature is provided through the Adesso server's “Program Guide,” “Subscriptions,” or “Now Playing” folders that store the files that users may choose to add to their available applications.

i. the files, alone or as stored in containers and/or folders, are displayed in thumbnail views in the form of .jpeg icons
ii. automated update the versions of the programs that are in the folder
   1. trigger
   2. needs to have connection to update this
   3. different from sync process
      1.7.4 As with FileSync, drag-and-drop gestures can be used to subscribe or unsubscribe from the content in a particular file, folder, and/or container.
iii. Subscription of the file results in a local copy being stored on the user's device.
   1. is it device specific, session specific or user specific?
      a. if a user subscribes using a laptop, and the user has a PPC and a laptop, does sync of the PPC end up installing a local copy of the subscribed folder on the PPC as well?
      b. Subscription may be device and/or user specific capable providing increased versatility.
iv. Deletion of an icon unsubscribes a user from a particular file, folder, and/or container.
   1. deletion of icon=unsubscribe NOT deletion of the file from the Adesso application, as file stored on server
   2. NOT analogous to regular FileSync where a user with permissions can delete the whole file with deletion of icon—here it is just to unsubscribe
      a. application manager has to delete files from the system, may cause local representations of file to be deleted
v. Unsubscription does not lead to change in permissions—the user can resubscribe at a later date

For example, file A may contain the most recent episode of The Today Show. A user with permission to access the file can choose to subscribe to the content by moving the icon representing the Today Show into their “Subscriptions” folder which provides a link to the file in the user's file sync table by adding and populating a record in the table. Additionally, a copy of the file may be saved on the user's computer, which is linked to the record in the file sync table. When the content of the Today Show file is updated (on the next day that it airs) and the user syncs, only the most recent copy of the program will be stored on the local computing device and the file sync table will reflect the new file's properties.

Data on Demand

1.7.4.1 The Adesso platform's use of the binary transfer cache table also allows for the synchronization process to be resumed at the place it stopped if the process is interrupted before completion. Once a file, folder and/or container is fully updated/synced, then the record is removed from the cache table. Since synchronization of files, folders, and/or containers is based on the cache table, Adesso can keep track of where the sync process left off. Therefore, if sync is interrupted, reinitiation of sync requires no duplicative downloading or uploading of information to the Adesso server.

According to one embodiment of the present invention a system is provided that supports the ability to selective transfer data between devices, including client and server and any combination thereof, such that it is possible to configure the system to allow user and/or programs the ability to determine pre (if information is available) or post synchronization process to transfer entities associated with one or more records. This is another optimization process for managing storage, bandwidth and time. The system supports a unique process for maintaining the synchronization of the relational database as well as the entity ←→ record relationship regardless of the presence of the file across all instantiations of the application. Download may be performed by file, by record, by view, by file or record size, by type, by project or application, by role, and/or by permissions. In one example, metadata may be transferred without transferring the actual data to permit the user to make an informed decision on whether the file or record should be tansferred.

Data Routing and Flow

1. The Adesso platform is designed to allow businesses to customize the platform to mirror their individual business processes without requiring (changes to the code).
   a. rapid application development
      i. Components of
         1. views
         2. forms
         3. expression language
            a. getmetadata
            b. getxmldata
         4. relational database design
            a. tables
            b. relationships
            c. fields
            d. filters
      ii. Creation and changes to forms, views, tables, fields, filters, records, and relationships can be made seamlessly
         1. dynamically (e.g., as changed by modifying the underlying database).
         2. without risk of data integrity stored within Adesso.
      iii. Changes to the application schema, underlying database, relationships, views, forms, etc. are isolated by using an abstraction layer between actual schema and what is represented to both designers and users of the Adesso application.
         1. The Adesso system may use a globally unique identifier (GUID) that is used to reference the actual database elements as well as components of the Adesso application, which are also stored as data within the relational database.
         2. By abstracting the actual database elements from the business logic, i.e. the views, forms, custom expression language statements
   b. synchronization
   c. provisioned applications and data (e.g., as part of synchronization)
2. Synchronization of any change pushes the new information out to all users in the field—allowing updates to be propagated company-wide virtually instantaneously. Additionally, alteration of the names of fields, tables, forms, filters and/or views does not affect any relationships in which data participates, either one-to-one or one-to-many relationships.

A one-to-one relationship links the data between two particular fields. For example, if an item in an inventory system is linked to its price, then when the item is ordered by a customer, the price information will be accessible without the application designer having to enter the information in twice. A one-to-many relationship links a single piece of data with more than one other piece of information. For example, the same item in inventory can be linked to both the price and its availability (in-stock v. backordered). This time when the customer orders the item, both the price and availability will be accessible to them, without the application manager entering the information into the home table.

Adesso's sync rules allow clients to systemize the routing of data along paths defined by a company's business logic. Sync rules are, according to one embodiment of the present invention, SQL queries that route the flow of data when a user synchronizes. Sync rules can be set for individual users or a group of users, and additionally can be based on the individual file, folder, and/or container updated upon synchronization.

Shell Extension

A record in the file sync table represents a link to the file and/or folder, with the actual storage of the file occurring outside of the Adesso application. Adesso's sync engine recognizes the special table, and updates both changes to the data within the file sync table as well as the file if it has been modified. Each file and/or folder stored in the file sync table has a set of properties that the Adesso application associates with it (ex. file size, last modified data, name, MD5 hash value, etc.). Upon sync, all fields with data about the file and/or folder, and the file and/or folder itself are checked for changes, and if changed are updated. If the file and/or folder has been renamed, sync updates the name of the file and/or folder associated with the file sync table; if the file and/or folder has been changed internally, sync replaces the past contents of the file and/or saved with the new version. Determination of changes, and the extent thereof, is made by comparing the initial file and/or folder properties with the subsequent file or folder properties. For each iteration of the file and/or folder, a new MD5 hash value that is associated with it is generated. Adesso supports any type of file—it is data agnostic—and can support any type of future file format.

High Level Flow

1. GUID used to uniquely identify record across one or more database instantiations

2. Record is associated to file via attributes (path, name, size, dig sig, etc.—optimization is key)

3. Change management
a. Manual or automatic checking of attributes maintains state between entity and record
b. Server-based change (i.e. remote change entity)
   i. Conflict resolution
   ii. Permissions-based control
   iii. Content routing control
c. Device-based change (i.e. local change to entity)
   i. Conflict resolution
   ii. Permissions-based control
   iii. Content routing control

4. File sync—triggers changes above, but in addition involves:

5. The GUID also acts as the basis of the one-to-one relationship between the record within the relational database and the entity (e.g., a file). Devices—need to identify as wide ranging list of devices as is possible

Relational database—a collection of data items organized as a set of formally-described tables from which data can be accessed or reassembled in many different ways without having to reorganize the database tables

Transactional systems

Normalized—any process that makes something more normal, which typically means conforming to some rule. In a database, this usually relates to the level of redundancy in a database's structure. Well normalized databases have a schema that reflects the true dependencies between tracked quantities, which usually allows updates to be performed quickly with little risk of data becoming inconsistent.

Container (Directory, File Folder)

Entity (File)

Storage device

1.7.4.1.1 On-Demand Download

1.7.4.2 According to one embodiment, system supports the ability to selective transfer data between devices, including client and server and any combination thereof, such that it is possible to configure the system to allow user and/or programs the ability to determine pre (if information is available) or post synchronization process to transfer entities associated with one or more records. This is another optimization process for managing storage, bandwidth and time. The system supports a unique process for maintaining the synchronization of the relational database as well as the entity ←→ record relationship regardless of the presence of the file across all instantiations of the application. Download may be performed by file, by record, by view, by file or record size, by type, by project or application, by role, and/or by permissions. In one example, metadata may be transferred without transferring the actual data to permit the user to make an informed decision on whether the file or record should be transferred.

Having thus described several illustrative embodiments, various alterations, modifications and improvements will readily occur to those skilled in the art. Such alterations, modifications, and improvements are intended to be within the spirit and scope of the invention. Accordingly, the foregoing description is by way of example only and is not intended as limiting.

What is claimed is:

1. A method for sharing data among a plurality of occasionally-connected systems, the method comprising acts of:
storing, at a first occasionally-connected system, a reference to a resource; and
presenting the reference, in a file system of the first occasionally-connected system, as a local resource in the file system.

2. The method according to claim 1, wherein the resource is stored at a remote location from the first occasionally-connected system.

3. The method according to claim 1, wherein the resource is stored locally in a file system of the first occasionally-connected system.

4. The method according to claim 1, further comprising an act of determining metadata associated with the resource, and storing the metadata in a database.

5. The method according to claim 4, further comprising an act of locating the resource using the database.

6. The method according to claim 4, wherein the act of determining metadata includes an act of analyzing data within a file associated with the resource.

7. The method according to claim 6, further comprising an act of determining a file format associated with the file, and determining metadata based on the determined file format.

8. The method according to claim 1, wherein the file system is presented to a user by a user interface, the user interface including a representation of the reference to the resource.

9. The method according to claim 8, wherein the representation is selectable by the user, and when selected, causes the resource to be downloaded to the first occasionally-connected system.

10. The method according to claim 8, wherein the representation includes a representation of a folder, and wherein the method further comprises presenting, through the user interface to the user, a representation of the folder.

11. The method according to claim 10, further comprising an act of downloading, in response to a selection of the folder representation, a list of one or more items contained by the folder.

12. The method according to claim 11, further comprising an act of downloading representations of the one or more items contained by the folder.

13. The method according to claim 12, further comprising an act of triggering a downloading of at least one of the one or more items in response to a selection of the at least one item by the user.

14. The method according to claim 8, wherein the user interface is presented through an extension of an operating system of the first occasionally-connected system.

15. The method according to claim 14, wherein the operating system is a WINDOWS-type operating system, and wherein the extension is performed using shell extension.

16. The method according to claim 8, further comprising an act of presenting a view of the file system using information derived from the file system.

17. The method according to claim 16, wherein the information includes metadata derived from a portion of at least one file, and wherein the method further comprises an act of determining the view of the file system based on the derived metadata.

18. The method according to claim 8, further comprising an act of permitting the user to perform at least one operation using the interface, the at least one operation comprising at least one of sorting files, filtering a listing of files, and presenting a view of files.

19. The method according to claim 17, further comprising an act of storing the derived metadata in a relational database.

20. The method according to claim 1, wherein the first occasionally-connected system includes a mobile computing system.

21. In a distributed computing system, a computer-implemented method for managing data, the method comprising acts of:
presenting, to a user, a representation of container;
accepting, from the user, an action relating to the container; and
executing a business process in response to the act of accepting.

22. The method according to claim 21, wherein the action includes the user selecting the container.

23. The method according to claim 21, wherein the action includes the user selecting one or more files in the container.

24. The method according to claim 21, wherein the action includes the user placing a file in the container.

25. The method according to claim 21, wherein the container includes at least one associated file, and wherein the method further comprises an act of associating the at least one associated file with a database entry of the distributed computing system.

26. The method according to claim 25, further comprising an act of identifying the at least one associated file within the distributed computing system.

27. The method according to claim 26, wherein the act of identifying further comprises an act of uniquely identifying the at least one associated file within the distributed computing system.

28. The method according to claim 24, wherein the file is a media file comprising at least one of audio data and video data.

29. The method according to claim 25, further comprising an act of accessing the file using the database entry.

30. The method according to claim 29, further comprising an act of performing a database search, a result of the database search providing the database entry.

31. The method according to claim 22, wherein the acts of presenting and accepting are performed by a mobile computing system operated by the user.

32. The method according to claim 31, further comprising an act of downloading, to the mobile computing system, information relating to the container.

33. The method according to claim 32, wherein the act of downloading is performed in response to an occurrence of a contextual event.

34. The method according to claim 32, wherein the information relating to the container includes a listing of one or more files associated with the container.

35. A method for providing content among a plurality of occasionally-connected systems over a communication network, the method comprising acts of:
providing for, at least one of the plurality of occasionally-connected systems, an indication by a user of the occasionally-connected system, a resource to be retrieved; and
retrieving, during a period of a connection of the at least one of the plurality of occasionally-connected systems to the communication network, the resource in response to the indication.
